(19) United States
(12) Patent Application Publication
(10) Pub. No.: US 2009/0147653 A1
(43) Pub. Date: Jun. 11, 2009

(54) Holographic content search engine for rapid information retrieval

(75) Inventors: David A. Waldman, Concord, MA (US); Joby Joseph, New Delhi (IN)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: STX Aprilis, Inc., Maynard, MA (US)

(21) Appl. No.: 12/288,357

(22) Filed: Oct. 17, 2008

Related U.S. Application Data
(60) Provisional application No. 60/999,481, filed on Oct. 18, 2007.

(51) Int. Cl. G11B 7/00

(52) U.S. Cl. 369/103; G9B/7

(57) ABSTRACT

An apparatus for information retrieval comprising a first holographic drive, configured to content-search holographic recording media (HRM), and to generate an address, and at least one data storage system, configured to receive the address generated by the first holographic drive and operable to retrieve information from said data storage system corresponding to the address received from said first holographic drive.

### RELATED APPLICATION

This application claims the benefit of U.S. Provisional Application No. 60/999,481, filed on Oct. 18, 2007. The entire teachings of the above application are incorporated herein by reference. This application also relates to a International Application filed under Attorney Docket No.: 3174.1027-002 (International Application No.: ______) on Oct. 17, 2008, Title: “OPTICAL SYSTEM AND METHOD FOR CONTENT ADDRESSABLE SEARCH AND INFORMATION RETRIEVAL IN A HOLOGRAPHIC DATA STORAGE SYSTEM”. The entire teachings of the above application is incorporated herein by reference.

### BACKGROUND

Search and retrieval of information from large and high-density databases is a time-consuming and complex task. Retrieval of data from a very high areal density holographic data storage is especially difficult due to a high degree of cross-talk between multiplexed data pages, resulting in low signal-to-noise ratio. A number of architectures for holographic drive systems have been disclosed, but they exhibit significant limitations.

In addition to superior data density and data transfer rate, volume holographic storage can also provide massive parallel search capability through the use of optical correlation methods based upon two-dimensional (2-D) cross-correlation between two images at a hardware level, such as disclosed by B. J. Goertzen et al., Volume holographic storage for large relational databases, Optical Engineering, 35(7), pp. 1847-1853, 1995.

### SUMMARY

The present invention is based on a discovery that content-searching of co-locationally recorded multiplexed holograms can be successfully performed even if the signal-to-noise ratio resulting from cross-talk between these multiplexed holograms is unacceptably low for reading or retrieval of the holographically stored information. This discovery permits construction of an apparatus and implementation of a method for rapid retrieval of information from an addressable database using an address obtained by content-searching an optionally separate very high density data storage that may be unsuitable for data retrieval. Information being retrieved can be stored on any memory system, such as holographic data storage.

In one embodiment, the present invention is an apparatus for information retrieval. The apparatus comprises a first holographic drive, configured to content-search holographic recording media (HRM), and to generate an address; and at least one data storage system, configured to receive the generated address, and operable to retrieve information from said data storage system located at the generated address.

In another embodiment, the present invention is a method of information retrieval. The method comprises content-searching a first holographic recording media (HRM), thereby generating correlation signals; generating an address based on the correlation signals; and retrieving information from at least one data storage system, said information located at the generated address.

In another embodiment, the present invention is an apparatus for information retrieval. The apparatus comprises a first holographic drive, configured to content-search holographic recording media (HRM), and to generate an address; and a first holographic recording media (HRM) in the first holographic drive, wherein said first HRM is content-searchable and non-retrievable.

In another embodiment, the present invention is an apparatus for content searching. The apparatus comprises a spatial light modulator (SLM) configured to generate a search argument beam; a first lens element, disposed in the optical path of the search argument beam, configured to direct the search argument beam at a selected storage location in a holographic recording media (HRM) and to generate a correlation signal beam in the event of a non-zero correlation; an elliposoidal reflector disposed in the optical path of the correlation signal beam; a detector configured to detect the correlation signal beam, wherein the correlation signal beam is reflected by the ellipsoidal reflector directly to the detector.

In another embodiment, the present invention is an apparatus for content searching. The apparatus comprises a spatial light modulator (SLM) configured to generate a search argument beam; a first lens element, disposed in the optical path of the search argument beam, configured to direct the search argument beam at a selected storage location in a holographic recording media (HRM) and to generate a correlation signal beam in the event of a non-zero correlation by diffracting the search argument beam; a beam dump, disposed in the optical path of the undiffracted of the search argument beam; a second lens element, disposed in the optical path of the correlation signal beam, configured to direct the correlation signal beam to the detector; a detector configured to detect the correlation signal beam, wherein the correlation signal beam is diffracted from the HRM directly at the second lens element.

In one embodiment, the first holographic drive can be configured to perform content-search only. In another embodiment, the second holographic drive can be configured to perform address-search only.

Advantageously, the content search can be performed on a holographic recording media recorded at a very high areal density of information. For example, binary data page holograms can be recorded at less than full Nyquist aperture, or multiplexed at less than Bragg selectivity angles or wavelengths, or combinations thereof, thereby achieving considerably higher areal storage density for multiplexed holograms in a storage location.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic representation of a process of recording an interference pattern between two coherent beams.

FIG. 1B is a schematic representation of a process of content-searching of a recorded hologram using an information-encoded search argument beam.

FIG. 2 is a schematic diagram of a 4-f holographic system.

FIG. 3 is an example of a Bragg selectivity plot of a hologram: a plot of intensity of diffracted light as a function of angle of incidence of a reference beam θ.

FIG. 4(a) through FIG. 4(h) illustrate the effect of varying width of an aperture used to record a binary data page hologram data page on the intensity distribution of the object beam at the Fourier transform plane.

FIG. 5 is a schematic diagram of one embodiment of an apparatus of the present invention.

FIG. 6 is a schematic diagram of another embodiment of an apparatus of the present invention.

FIG. 7 is an embodiment of a holographic drive suitable for content-searching a holographic recording media.

FIG. 8 is another embodiment of a holographic drive suitable for content-searching a holographic recording media.

FIG. 9 is another embodiment of a holographic drive suitable for content-searching a holographic recording media.

FIG. 10 is another embodiment of a holographic drive suitable for content-searching a holographic recording media.

FIG. 11 is a schematic diagram showing detail of an embodiment of a holographic drive suitable for practicing content search.

FIG. 12 is a schematic diagram showing detail of an embodiment of a holographic drive suitable for practicing content search.

FIG. 13 is another embodiment of a holographic drive suitable for content-searching a holographic recording media.

FIG. 14 is another embodiment of a holographic drive suitable for content-searching a holographic recording media.

FIG. 15 is another embodiment of a holographic drive suitable for content-searching a holographic recording media.

FIG. 16 is another embodiment of a holographic drive suitable for content-searching a holographic recording media.

FIG. 17 is a diagram illustrating a superpixel indexing scheme employed by an embodiment of the present invention.

FIG. 18(a) through FIG. 18(d) are photographs showing the appearance of co-locationally recorded multiplexed holograms recorded with varying Bragg conditions for increments of reference beam incidence angles.

FIG. 19(a) through FIG. 19(d) are photographs showing the appearance of co-locationally recorded multiplexed holograms recorded with varying Bragg conditions for increments of reference beam incidence angles and apertures for the area exposed during recording.

### DETAILED DESCRIPTION

As used herein, the terms “information” and “content” are used interchangeably to refer to data stored in a data storage system. As used herein, the term “address search” means retrieval of the desired data, based on the address at which this is stored. As used herein, the term “content search” means ascertaining the presence of given information in a database and optional retrieval of one or more addresses at which this information is stored, based on partial or complete information about the content of this data. As used herein, the term “content-searchable” refers to a data storage media, having information stored thereon, wherein the presence of desired information in such a storage can be ascertained while the information itself may or may not be retrieved or read. The term “address-searchable” refers to a data storage media, having information stored thereon, wherein the desired information can be retrieved or read based on its location (address) in the data storage. The term “non-retrievable” refers to a data storage media, having information stored thereon, wherein the retrieval or reading of the recorded information, for example, holographically recorded information, from the media may be impossible or impractical due to the manner of recording the information. See the description below pertaining to recording multiplexed holograms in a holographic recording media (HRM) at sub-Bragg angular separation or wavelength separation, sub-Nyquist aperture, etc., or combinations thereof.

The devices and method of the present invention relate to methods and devices for rapid search of a large addressable data storage for a desired information (e.g., a file) and to retrieving this information. A part of or the entirety of the content of the addressable data storage can be recorded holographically on a first holographic recording media (HRM) at such a high areal density that the retrieval of the recorded information from the first HRM may be impossible or impractical. However, the said first HRM can still be content-searched. Based on the non-zero result of the content searching of the said first HRM, an address at which the desired information is stored in the addressable data storage can be computed or looked up. Using the generated address, the desired information can be retrieved from the addressable data storage.

In certain embodiments, the first holographic drive can include the first holographic recording media (HRM) disposed therein. The first HRM can include holographically stored information recorded thereon as multiplexed volume holograms. The multiplexed holograms can be recorded on the first HRM using two or more multiplexing methods (discussed in details below). In some embodiments, the first HRM is content-searchable, but the holographically stored information cannot be read due to inadequate signal-to-noise and is thus non-retrievable. The holographically stored information can be recorded on the said first HRM at areal density having values of 100 bits/μm² or substantially more. The multiplexed holograms can be recorded on the said first HRM at sub-Bragg angular or wavelength separation. The multiplexed holograms can be recorded on the said first HRM using sub-Nyquist aperture. The multiplexed holograms can be recorded on the said first HRM using both sub-Nyquist aperture and sub-Bragg angular or wavelength separation. The multiplexed holograms, recorded on the said first HRM, can have raw bit-error-rate (BER) of 0.01 or greater. The multiplexed holograms, recorded on the said first HRM, can have signal-to-noise ratio (SNR) of 2 or less.

### Optical Correlation Search

Optical correlation search in volume holographic data storage systems can be carried out using a conventional 4-f recording geometry among others.

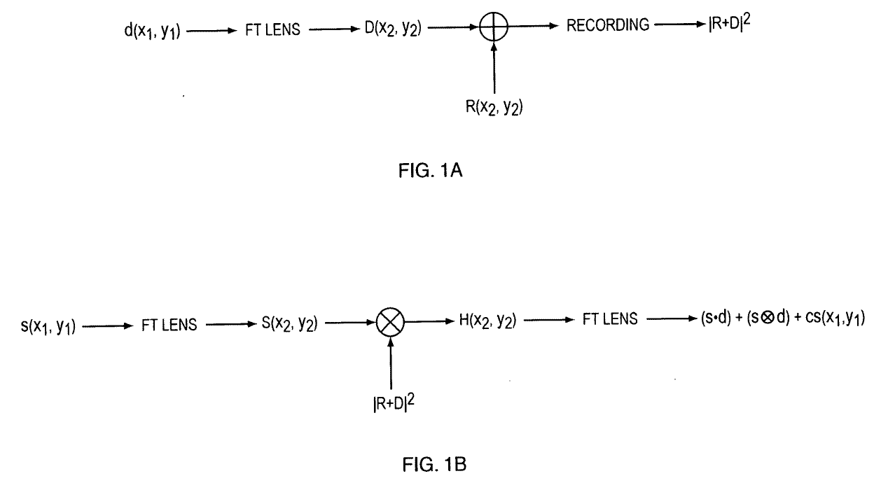

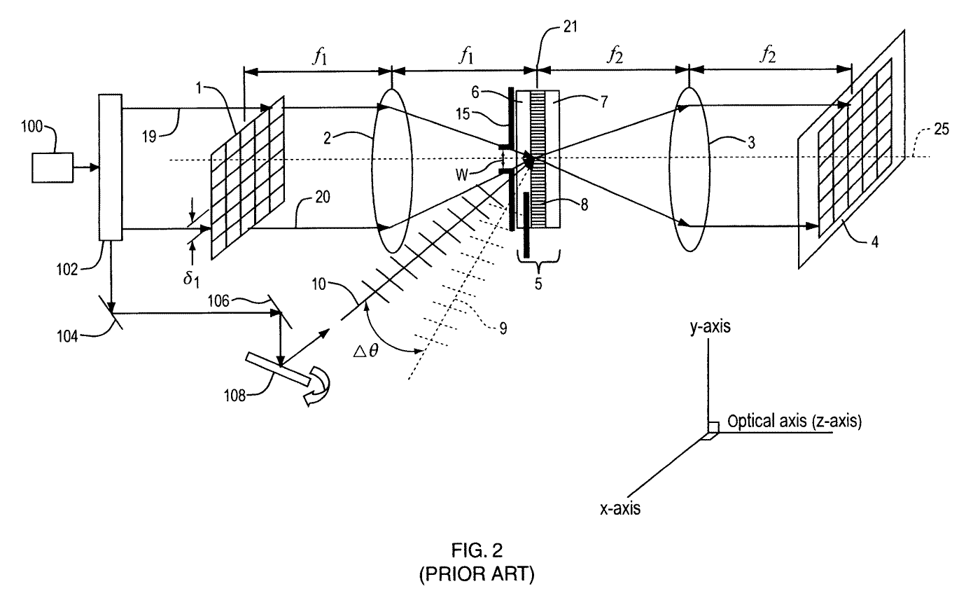

FIG. 1A is a schematic representation of a process of recording an interference patter between two coherent beams. FIG. 1B is a schematic representation of a process of content searching of a recorded hologram using an information-encoded search argument beam.

Referring to FIG. 1A and FIG. 1B, one can define a spatially modulated 2-D data page signal, given by the spatial intensity distribution d(x₁,y₁), that can be formed on a pixellated input device known as a Spatial Light Modulator (SLM) such that d(x₁,y₁) is encoded onto a input laser beam to form the object beam. Using the Fourier Transform property of a lens, the spatial 2-D Fourier spectrum of di(x₁,y₁) is obtained at the back focal plane of the said lens yielding D₁(x₂,y₂). An additional reference wave R₁(x₂, y₂), coherent with the laser beam path used to form the object beam, is propagated so as to interfere with the 2-D Fourier spectrum of the 2-D data page signal, D₁, of a first modulated data page. A holographic recording medium placed at or near the Fourier plane records, within the volume of the media, a signal representing the interference between R₁ and D₁. As used herein, the term “near” refers herein to a distance before or after the Fourier plane, wherein said distance can be up to about 30% of the value of the focal length of the lens. The interference pattern signal has the intensity represented by |R+D|². The recording, in one class of recording material, occurs by way of photopolymerization reactions that create chemical segregation of chemical structures having different refractive indices thereby forming a microstructure that exhibits refractive index modulation corresponding to the presented interference pattern. Other classes of materials are contemplated for use as recording materials, such as, by way of example, photorefractive crystals, materials comprising photochromic compounds, photorefractive polymers, and the like.

This process is repeated for subsequent recordings of a 2^{nd} modulated data page, 3^{rd} modulated data page, and so forth. For example, the second and the third data pages each is a signal having amplitude represented as D₂(x₂, y₂) and D₃(x₂, y₂), respectively. Subsequent to recording, if a search pattern signal (also referred to herein as a search argument signal) s(x₁,y₁) displayed on SLM is incident upon the lens, the 2-D Fourier transform S(x₂,y₂) is presented to the locations of one or more recorded holograms in the media positioned at or near the back focal plane of the lens. The signal S(x₂,y₂) is multiplied (diffracted) by the structure formed from the interference pattern signal having intensity |R+D|², which now represents the corresponding stored holograms in the media. This results in yielding a new signal H(x₂,y₂) comprising the correlation signal that can be distinguished from the non diffracted transmission of S(x₂,y₂) through the media. The present invention also contemplates structures formed from an interference pattern signal having intensity |R+D|², wherein the corresponding stored holograms in the media are reflection holograms. In this case, signal H(x₂,y₂), which would comprise the correlation signal, would be a reflection signal. If the multiplied image H(x₂,y₂) is passed through a second Fourier transform lens, two signals result, the correlation of s(x₁,y₁) and d(x₁,y₁) and the convolution of s(x₁,y₁) and d(x₁,y₁) plus an attenuated search signal. When the recording plane is at a fractional Fourier plane position, the resultant signal will be a modified form of H(x₂,y₂).

A parallel search can preferably be executed when a plurality of holograms storing information are recorded co-locationally in a storage location. In said case, the correlation of a search argument with a plurality of co-locationally multiplexed holographic gratings can produce a plurality of search result optical signals simultaneously. The intensity of each said optical signal is related to the strength of the correlation between the search argument and the information stored as holograms. multiplexed holograms in a storage location.

### Planar Angle (Bragg) Multiplexing—An Exemplary Multiplexing Technique

FIG. 2 schematically depicts elements of a typical optical imaging system for holographic recording and reading, referred to as a 4-f system when f1=f2. Optical element (102), which may include a grouping of one or more elements such as a beam splitter, polarizer element, waveplate, spatial filtering system, apodizer, lens elements for beam expansion and/or collimation, mirror elements for redirection of light from laser (100), and the like, operates to provide incident light beam (19), usually collimated light of substantially uniform intensity, from laser source (100) to SLM (1). Typical systems include a spatial light modulator (SLM) (1), that encodes the incident light beam (19) from light incident upon SLM (1) from a source such as laser (100) to generate object beam (20), lens elements (2) and (3) that have common optical axis (25) and are located at distances of focal length f1 and f2 from the SLM (1) and digital detector (4), respectively, and the media (5) that may be a disk, card, cube, cylinder or other suitable form factor and which comprises, by way of example, substrates (6) and (7) that may be optional, and a recording material (8) that may, by way of example, be a photopolymerizable material, photorefractive material, photochromic material, combinations thereof and the like. Media (5) having active material without substrates is also contemplated by the present invention.

The generated object beam (2) for recording is depicted as amplitude modulated pattern. Alternatively, the said object beam for recording may be phase modulated, such as by 0, π phase or other suitable phase modes. While FIG. 2 depicts recording of transmission holograms, the present invention is not restricted to transmission holograms. Other suitable recording geometries are also contemplated such as for reflection holograms, wherein the Object and Reference beams are incident to the media from directions that are oriented with respect to opposing sides of the media, or for recording holograms in 90 degree geometry whereby the angle between the Object beam (20) and the Reference beam (10) is equal to 90 degrees. Other optical recording/reading imaging systems are also contemplated, such as 6-f or 8-f systems or the like that may be used for improved Signal-to-Noise (SNR) for content retrieval, or other systems that are non 4-f (i.e. f1≠f2) and which, by way of example, can provide for magnification or demagnification that may be used to match pixel dimensions corresponding to one or more pixels of the SLM to pixel dimensions of one or more pixels of the digital detector (i.e. CMOS), or phase conjugate systems, and the like.

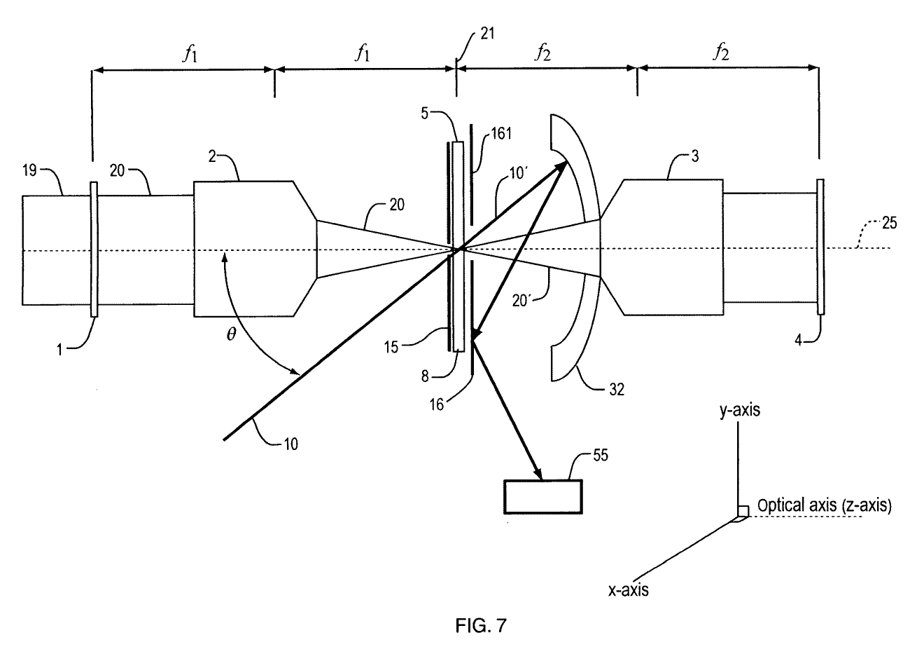

Optionally, an aperture element (15) may be located at or near the front surface of the media (5), so as to restrict the illuminated region at a storage location such that the areal density is optimized with respect to bit-error-rate (BER) and other parameters. Aperture element (see element (15) in FIG. 7) may alternatively be integral to the media, such as a layer or surface of the media that may, by way of example, be electrically or magnetically active, such as due to an electroclinic effect from a surface or intermediate layer, and may be addressable for different locations across the area of the media. Also shown in FIG. 2 are a group of alternative positions of a Reference beam, depicted as bounded by beam (9) and beam (10). This group of positions includes angles between beams (9) and (10). Beam (9) and beam (10) are separated by angle AO. Reference beam (9) is depicted to represent a Reference beam that is separated by angle increment, AO, from the incident angle of the position of Reference beam (10) with respect to the optical axis (25) of the signal beam (20). Further, said Reference beam (9) can be in a common plane with the location of Reference beam (10) and said optical axis (25) or, alternatively, can be out of said plane. The position of reference beam (10) in FIG. 2 is depicted to be at about the smallest incident angle that clears the housing of lens (2). Plane (21) is the Fourier transform plane of lens element (2).

FIG. 2 also schematically shows the operation of a typical 4-f system during recording a hologram. Recording is carried out by presenting media 5 with an encoded Object beam (20), propagated by lens element (2) from SLM (1), and a Reference beam (10), also from a light source such as laser (100). As shown in FIG. 2, the output of laser 100 that can be modified and/or redirected by element (102) and other elements as may be necessary, such as mirror elements (104), (106) and (108), onto recording media (5). Mirror (108) or other mirror elements may be rotatable by a motive device about one or more axes and the optical elements for generating the Reference beam (10) may also comprise other optical elements such as for imaging Reference beam (10) onto recording media (5). As a result, and as shown in FIG. 2, Reference beam (9) may be directed at media (5) at an incident angle different from the angle of Reference beam 10, but may be incident at the same location on media (5).

Reference beam (10) is shown to be incident upon recording media (5) at an oblique external angle θ with respect to optical axis (25) of the depicted 4-f optical system, wherein θ is an angle of rotation about an axis perpendicular to axis (25). During the recording, Object beam (20) and Reference beam (10) are substantially coherent and are directed to the media so as to overlap in the volume of the recording location in recording material (8) and thereby form an interference pattern in said volume that preferably is a stationary interference pattern on the time scale of recording.

An “interaction plane” is defined herein as a plane that contains both Reference beam (10) and the optical axis (25) of Object beam (20). In FIG. 2, the optical axis of the Object beam (20) is shown to be coincident with optical axis 25. Reference beam (10) in FIG. 2 is incident at an oblique angle θ with respect to optical axis (25), and is in the x-z plane, thus θ is shown to be selected from one or more of a grouping of angles about the shown y-axis, each said angle being perpendicular to the y-axis, and the optical axis (25) is also shown to be perpendicular to the y-axis. Multiplexing of holograms in a storage location can be based upon recording multiple holograms using different values of the angle θ. Recording a group of two or more holograms co-locationally, each with a plane wave reference beam (10) incident at a different angle θ, is referred to as planar-angle multiplexing, or in-plane angle multiplexing, and is a Bragg method for multiplexing. For such a method of multiplexing, the maximum number of co-locationally recorded holograms is directly related to the thickness of the recording material (see E. N. Leith et al. in Applied Optics, Vol. 5, No. 8, pp. 1303-1311, 1966). Increment Δθ shown in FIG. 2 represents a range of planar Reference beam angles θ that may be used for recording planar-angle multiplexed volume holograms in a selected storage location.

### Bragg Selectivity of Planar-Angle Multiplexed Holograms

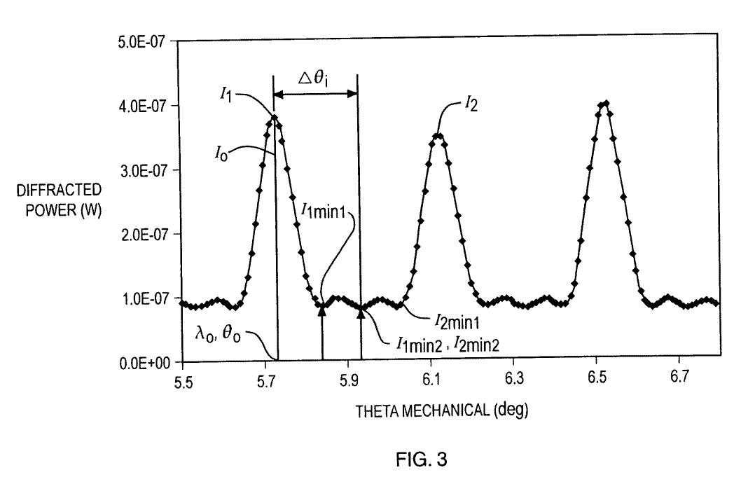

FIG. 3 is a plot showing measured power (intensity or brightness) of diffracted light in Watts per unit area as a function of angle of incidence of a Reference beam θ. The detected brightness of a recorded hologram, referred to as diffracted intensity (I), varies with either the wavelength λ of the incident Reference beam used to reconstruct the hologram, or angle θ between such a Reference beam and a normal to the surface of the holographic recording medium. The detected brightness can additionally be dependent upon position of the Reference beam incident upon a storage location with respect to the center of a hologram in a storage location. (For example, in the case of a spherical wavefront used in shift multiplexing, the tangential, δₜ, and/or radial, δᵣ, position of the incident Reference beam wavefront is incremented by an amount Δδₜ and Δδᵣ, respectively, between proximal multiplexed holograms.) In FIG. 3, the curve plotted through the data points, for a group of planar-angle multiplexed binary page holograms, is referred to as a Bragg selectivity (either angular or wavelength) or “detuning curve” for the reconstruction of a hologram.

As shown in FIG. 3, the highest brightness of the detected hologram is achieved at angle θ₀ and wavelength λ₀ that correspond to the position of the primary diffraction peak (I₀). (Similarly, the highest brightness of the detected hologram is achieved at positions δₜ_{ₒ} and δᵣ_{ₒ} for shift-multiplexed holograms.) The primary diffraction peak of the first hologram of a grouping of 3 planar-angle multiplexed holograms, having intensity I₁, is separated from the primary diffraction peak of the second hologram, having intensity I₂, by a first minimum I₁ₘᵢₙ₁, second minimum I₁ₘᵢₙ₂, and third minimum I₁ₘᵢₙ₃ of the first said hologram. (The minima are sometimes referred to as nulls). In the example shown, the second minimum of the first hologram I₁ₘᵢₙ₂ closely coincides with the second minimum of the second hologram I₂ₘᵢₙ₂ and the third minimum of each hologram (I₁ₘᵢₙ₃, I₂ₘᵢₙ₃, I₃ₘᵢₙ₃) closely coincides with the 1^{st} minimum of the neighboring primary diffraction peak.

Further, a first group of planar-angle multiplexed holograms in a storage location may be shift multiplexed from a second proximal grouping of planar-angle multiplexed holograms, so as to at least partially spatially separate the said proximal first and second groupings. If the spatial separation is partial between the two proximal groups, such that the two groups are partially overlapping with respect to the locations of their areas at the surface of the recording material and/or their volumes in the volume of the recording material, then the set of planar-angles selected for the first group can optionally differ from the set of planar-angles selected for the second group by an increment necessary to achieve differentiation between the multiplexed holograms of the two groups. The difference between the selected planar angles is based upon Bragg selectivity characteristics of the multiplexed holograms, which will be defined below.

Typically, holograms are multiplexed so that the primary diffraction peak of a first hologram is separated from the primary diffraction peak of a second hologram in the same storage location, for co-locationally multiplexed holograms, or from the primary diffraction peak of the next proximal shifted location for shift multiplexed holograms, by an increment in angle, wavelength or position that is approximately equal to the change in angle, wavelength or position distance between the primary diffraction peak and the second minimum of the first hologram. This separation typically results in good signal-to-noise ratio during reconstruction of the holograms. This type of separation is sometimes referred to as “peak-to-2^{nd}-null separation”. This type of multiplexing is often implemented because the first minimum of a given hologram can exhibit significant uplift from the noise-level signal of the reconstructed hologram while the second minimum exhibits reduced uplift.

### Content-Searching of Very High Areal Density Holographic Storage

In certain embodiments, the present invention is a method and a device that permit rapid access to files (information retrieval) in at least one memory system. The information stored in the memory system is retrieved using an address obtained by content-searching holographically stored information in a recording media (HRM).

In a preferred embodiment, the angle, wavelength or position between Reference beams used to record two or more co-locationally multiplexed holograms, or two or more proximal shifted holograms, is less than the above-referenced “peak-to-2^{nd}-null separation” along the Bragg selectivity curve. For example, the angular, wavelength, or positional distance between two multiplexed co-locationally recorded holograms, or two or more proximal shifted holograms, can be “peak-to-1^{st}-null”

The less than “peak-to-2^{nd}-null separation” permits achieving substantially higher areal density of stored information. As a result, an apparatus can be constructed and a method can be implemented for rapid retrieval of information, such as from a database or enterprise storage system or archival storage system, using an address obtained by content-searching media having high density data storage. The very high density data storage can be suitable for content searching, but may be unsuitable for retrieval of the holographically stored information that is searched. Information can be stored on any memory system, such as holographic data storage systems, or storage systems comprising one or more magnetic tapes, hard disk drives, solid state drives, semiconductor memory, flash drive units, optical disks or tapes, magneto-optical disks and the like.

In a further preferred embodiment, for multiplexed holograms that are to be searched for content but not reconstructed for retrieval, the increment of separation between Reference beams used to record the multiplexed holograms co-locationally (or the increment of proximally shifted holograms) can be less than the separation between the primary diffraction peak and the first null along the Bragg selectivity curve.

By way of example, the increment Δθᵢ, shown in FIG. 3 for planar-angle multiplexed holograms, can be reduced from the value of the conventional distance from peak I₁ to the second null I₁ₘᵢₙ₂ to a value Δθᵢ/n, where n is a number between about 2 and 30 and where n may be fractional or whole number. Preferably, the increment Δθᵢ/n is significantly less than the “peak-to-1^{st} null” distance along the Bragg selectivity curve, thereby providing for significantly increasing the multiplexing factor, e.g. by factors of at least 5. This, in turn, more fully utilizes the accessible dynamic range of the recording material in a unit thickness and substantially increases the attainable areal density for the holographically stored information.

Multiplexing holograms using increments having separation of Δθᵢ/n or Δλᵢ/n or Δδₜ/n or Δδᵣ/n, or combinations thereof, where 2≦n≦30 advantageously provides for substantially higher capacity per unit thickness of the recording media, higher data rates, and higher information/data search rates. Applicants have discovered that holograms recorded in this manner can be readily differentiated during content-search, particularly when the optical encoding device (SLM) is operable in phase mode (see for example J. Joseph and D. A. Waldman, “Homogenized Fourier transform holographic data storage using phase spatial light modulators and methods for recovery of data from the phase image” Appl. Opt., 45, 25, 6374-6380 (2006) the entire teachings of which are incorporated herein by reference). This improvement is at least comparable to the improved multiplexing factor that can otherwise be achieved by combining multiplexing methods, such as planar-angle and azimuthal or tilt (out-of-plane angle) or shift in tangential and shift in radial directions, or wavelength, but advantageously the opto-mechanical system for recording and/or reading can be simplified by comparison to what is required when combining multiplexing methods.

Referring to FIG. 2, in a general holographic data storage system, an aperture element (15), such as element having an opening of area A, is optionally inserted at or near the front surface of the media (5) or at or near the Fourier transform plane of the lens element (2)) to restrict the illuminated region at a selected storage location. Aperture element 15 comprises an opening (aperture), having width W. Insertion of aperture element 15 permits optimizing areal density of the holographically stored information with respect to bit-error rate (BER) and other desirable parameters. Aperture element (15) may alternatively be integral to the media, such as a layer or surface of the media that may, by way of example, be electrically or magnetically active, such as due to an electroclinic effect from a surface or intermediate layer, and may be addressable for different locations across the area of the media. The area A of the aperture element (15) is generally defined with respect to Nyquist aperture (N_{A}). N_{A} is an aperture having a width defined as Nyquist width (N_{w})=2λf/b, where λ is the wavelength of light for recording/reading, f is the focal length of lens element (2) and b is the pixel pitch of the SLM (1).

One of ordinary skill in the art will appreciate that better BER performance is obtained in a holographic data storage system when the width of the aperture element (15) is greater than or equal to about 1.2 times N_{w}. (The width of aperture element 15 can be even larger when any additionally needed size that compensates for shadow effects related to use of a reference beam at oblique angles with respect to the perpendicular to the media is taken into consideration.) Referring to FIG. 2, in an alternative embodiment, an aperture element of dimensions N_{w} or greater than or equal to 1.2 times N_{w} can be positioned at the Fourier transform plane in an optical relay system positioned between lens element (3) and detector (4), thereby operating as a Fourier plane filter. Further, for the case of fractional Fourier transform plane recording the aperture element (15) can be placed at the Fourier transform plane of lens element (2), wherein the Fourier transform plane can be directly in front of or behind media (5).

In one embodiment of the present invention, in order to record a very high density HRM that can be content-searched, but may be unsuitable for content retrieval of the holographically stored information that is searched (address search), width W of the opening in aperture element (15) (not including a size increment needed to compensate for a reference beam being at oblique angles) is reduced to less than N_{A} such that substantially higher areal density of holographically stored information can be achieved for the recorded information when the system is used for data search purposes.

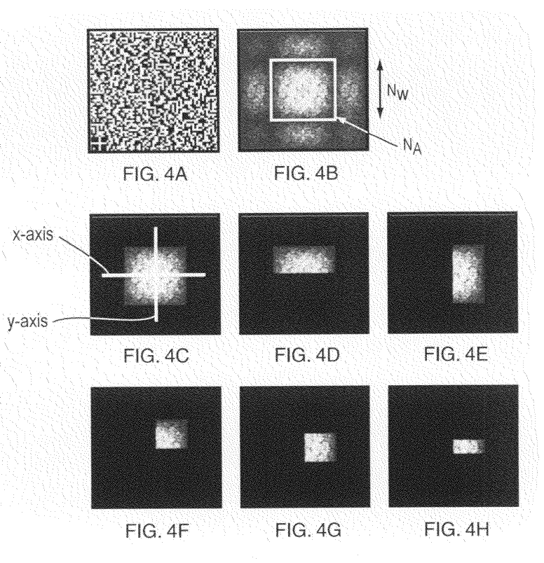

The effect of varying width W in aperture element 15 is illustrated in FIG. 4(a) through FIG. 4(h). FIG. 4(a) shows a portion of a binary data page with balanced number of “1” and “0” values for bright and dark pixels, respectively. FIG. 4(a) also shows a fiducial marking, shown in the lower left corner. FIG. 4(b) shows the Matlab simulation of the intensity distribution of the Fourier transform (FT) of the full binary data page of FIG. 4(a), where the outlined white rectangle represents the aperture of size N_{A} with width N_{w}. FIG. 4(c) shows the FT intensity distribution transmitted by an aperture of size N_{A}. FIG. 4(d) through FIG. 4(h) show the FT intensity distributions transmitted by an aperture having sizes with respect to N_{A} that are 0.5 N_{A} along the horizontal dimension above the x-axis (can also be below the x-axis) of the FT intensity distribution, 0.5 N_{A} along the vertical dimension to the right (can also be to the left) of the y-axis of the FT intensity distribution, 0.25 N_{A} aligned for a quadrant (can be any of the 4 quadrants) of the N_{A}, 0.25 N_{A} aligned for a 0.125 area section to the right of the y-axis (can be to the left of the y-axis) above the x-axis combined with a 0.125 area section to the right of the y-axis (can be to the left of the y-axis) below the x-axis of the N_{A}, and 0.125 N_{A} aligned for 0.0.0625 section to the right of the y-axis (can be to the left of the y-axis) above the x-axis combined with a 0.0.0625 section to the right of the y-axis (can be to the left of the y-axis) below the x-axis of the N_{A}, respectively.

### Holographic Content Search Engine for Rapid Information Retrieval

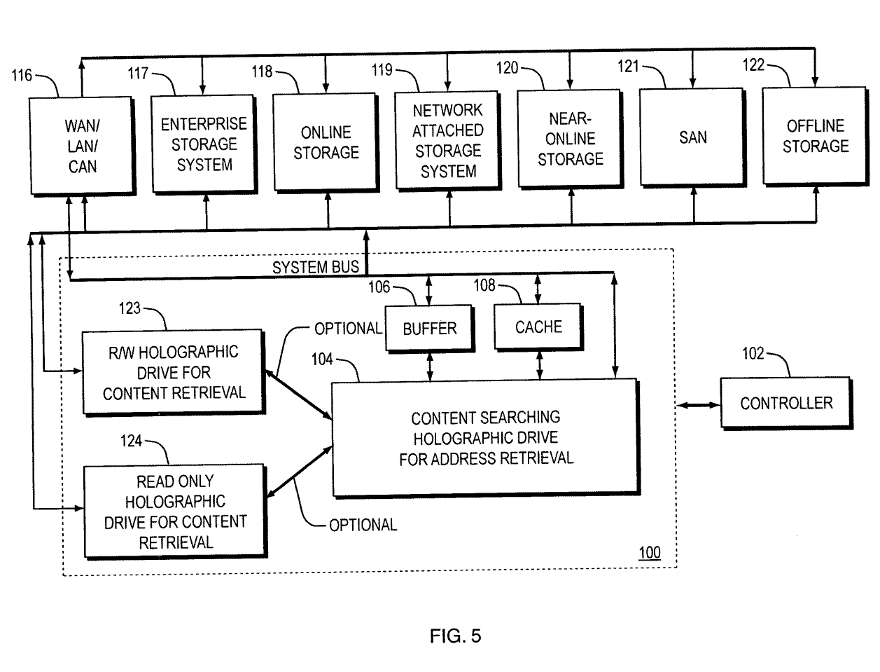

FIG. 5 is a schematic diagram of one embodiment of an apparatus of the present invention. Apparatus (100) includes holographic drive 104, configured for content searching (address retrieval) of a holographic recording media (HRM). Apparatus 100 can also include optional holographic drives 123 and 124 in communication with holographic drive 104, and optionally in communication with other storage systems, or networks having storage systems, shown in FIG. 5 as elements 116-124. Holographic drive 123 can be configured to perform address searching (content retrieval) and can be a read/write holographic drive. Holographic drive 124 can also be configured to perform address searching (content retrieval) and can be a read only holographic drive. Apparatus 100 further includes a data buffer 106, and a cache device 108. The operation of apparatus 100 can be controlled by controller 102.

In one embodiment, holographic drive 104 can be configured to perform content-search only. In certain embodiments, holographic drives 123 and 124 can be configured to perform address-search only.

As discussed above, in certain embodiments, holographic drive 104 can include a holographic recording media (HRM) (not shown in FIG. 5), having holographically stored information recorded thereon. This HRM can include information recorded thereon as multiplexed volume holograms. The multiplexed holograms can be recorded on the HRM using two or more multiplexing methods (discussed in details below). In some embodiments, this HRM can be content-searchable, but the holographically stored information that is searched is non-retrievable. For example, the holographically stored information can be recorded on the HRM at areal density of 100 bits/μm² or substantially more. The multiplexed holograms can be recorded on the first HRM at sub-Bragg angular or wavelength separation. The multiplexed holograms can be recorded on the first HRM using sub-Nyquist aperture. The multiplexed holograms can be recorded on the first HRM using both sub-Bragg angular or wavelength separation and sub-Nyquist aperture. The multiplexed holograms, recorded on the first HRM, can have raw bit-error-rate (BER) of 0.01 or greater. The multiplexed holograms, recorded on the first HRM, can have signal-to-noise ratio (SNR) of 2 or less.

In one embodiment, apparatus 100 obtains addresses of holograms stored in the HRM disposed within drives 123 or 124, or otherwise accessible by drives 123 or 124, by content searching an HRM disposed in drive 104. Drive 104 detects correlation signal beams generated by diffraction of search argument beams incident on holograms, optionally multiplexed, stored in the HRM disposed within drive 104. This provides the means to look up and/or locate content stored in other memory systems, such as the HRM disposed in drives 123 or 124, or otherwise accessible by drives 123 or 124, said content corresponding, at least in part, to the search arguments in the content addressable search operation. Furthermore, upon retrieval of the one or more addresses by drive 104, the information stored that corresponds at least in part to said addresses can be retrieved from other sources of stored information. These other sources can be structured or unstructured information stored in data storage systems such as one or more magnetic tapes, hard disk drives, solid state drives, semiconductor memory, flash drives, optical disks or tapes, magneto-optical disks/drives, holographic disks/drives and the like or combinations thereof. FIG. 5 schematically represents these memory systems as elements 117-124, and said systems may be communicated with using networks 116 that comprise said systems.

Retrieval of content (information) from each data storage system 117-124, or from networks 116 comprising such data storage systems, can be performed independently or in combination with other data storage systems, including drives 123 or 124.

Alternatively, apparatus 100 can be part of Hybrid Data Storage systems described in U.S. Pat. No. 6,904,491 or EP 1402522, the entire teachings if which are incorporated herein by reference.

In one embodiment, read/write (R/W) holographic drive 123 and read-only holographic drive 124 can be included in the apparatus 100. Alternatively, drives 123 and 124 can be independently accessed by apparatus 100 similarly to data storage systems 117-122.

Controller (102) can be used to request and/or receive the one or more addresses obtained from the drive 104 from the search operations carried out by drive 104. Additionally, controller (102) can direct the request and/or retrieval of the information from other memory system (sources of stored information) 117-124, said information corresponding, at least in part, to the search arguments in the content addressable search operations that generated one or more non zero correlation signal beams. Controller 102 can be a component of an apparatus that detects and retrieves addresses in response to requests from a client for address-retrieval (i.e. content-search of the HRM disposed in drive 104) to locate information stored at the retrieved address in other data storage systems 117-124, or networks 116 communicating to such systems, said information corresponding, at least in part, to the search arguments in the content addressable search operations that generated one or more non zero correlation signal beams.

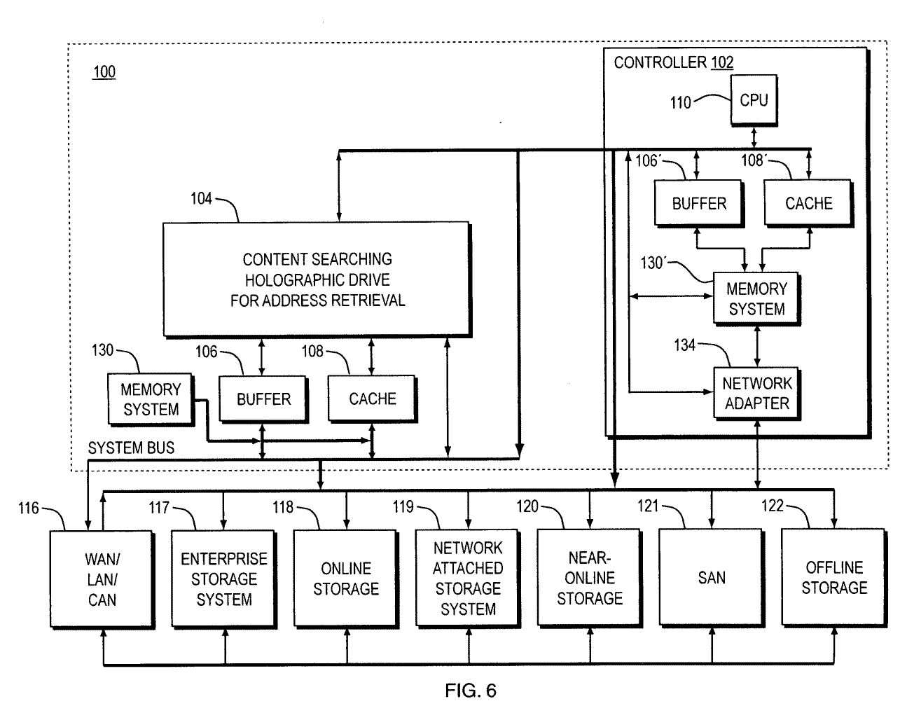

FIG. 6 is a schematic diagram of another embodiment of an apparatus of the present invention. Controller (102) can be a separate device, as shown in FIG. 5, or can be a part of apparatus (100), as shown in FIG. 6. In either embodiment, controller 102 can provide further capabilities for processing and arbitration. In such systems, controller (102) can receive and transmit information directly from/to elements other than drive (104). Examples of such elements include WAN, CAN and/or LAN (116), the enterprise storage (117), the online storage (118), the network storage system (119), the near-online storage (120), the SAN (121), and/or the offline storage (122), or any other suitable source of information.

In the embodiment of FIG. 6, apparatus 100 includes content-searching holographic drive 104, data buffer 106, cache device 108, and memory system 130. Apparatus 100 also includes controller 102. Data buffer 106 and cache device 108 are in communication with drive 104 as well as memory system 130. Data buffer 106, cache device 108 and drive 104 are in communication with controller 102. Controller 102 comprises a central processing unit (CPU) (110) which interfaces to other sources of stored information such as elements 117-122 through a system bus. Controller 102 also includes data buffer 106′, cache device 108′, memory system 130′ and network adapter 134.

Network adapter (134) can also be an adapter for interfacing to optical communications carried along optical fiber, through space, or using integrated optics, or combinations thereof, for wireless communications, and, for example, can communicate with the WAN/LAN/CAN (116), enterprise storage system (117) online storage system (118), network-attached storage (NAS) system (119), near online storage system (120), storage attached network (SAN) system (121) or offline storage system (122), using protocols as may be necessary or advantageous such as for communication through a network adapter.

In the embodiments shown in FIG. 5 and FIG. 6, the information can be requested, accessed and retrieved from a data storage system via local area networks (LAN), wide area networks (WAN), campus area networks (CAN) (element 116 in both FIG. 5 and FIG. 6). In the embodiments shown in FIG. 5 and FIG. 6, cache devices (108), independently or in conjunction with data buffers (106), can be used to substantially optimize the access and retrieval of information in a particularly useful format by way of facilitating the transfer of the retrieved information. Controller (102) can be provided with data management software, and may also maintain one or more file directories for locating data files.

Referring to FIG. 5 and FIG. 6, apparatus (100) can receive requests for content-searching an HRM disposed in drive 104, retrieve one or more addresses at which information is stored, locate the stored information at the one or more retrieved addresses and retrieve the stored information from a data storage system. The requests for content-searching (address retrieval), distribution of retrieved address, and retrieval of the information stored at the retrieved address on any of the data storage systems 117-122 and/or drives 123 or 124 can be performed through an interface to a WAN, one or more LANs, or CAN (116). Requests for content-searching (address retrieval), distribution of the retrieved address, and retrieval of information stored at the retrieved address from any data storage systems can occur directly or with use of controller (102) and/or optionally the use of cache device (108) and/or data buffer (106). (One or more LAN (116) can also be a dedicated LAN.)

Additionally, the embodiments of the devices shown in FIG. 5 and FIG. 6 can comprise or interface with multiple controllers (not shown) for optimizing process loads for writing and/or reading from separate devices that may be used for the content search and/or address search (information retrieval) modes. Preferably, such controllers use separate I/O data streams. For example, controller (102) of either FIG. 5 or FIG. 6 may also function as an arbiter between the client making requests for content-searching an HRM disposed in drive 104 and address-searching other data storage systems such as systems 117-122, as well as an HRM disposed in drives 123 or 124 (see FIG. 5).

Referring to FIG. 5 and FIG. 6, file management and network communication can be performed by controller (102) on a network server (not shown).

The cache devices of the embodiments shown in FIG. 5 and FIG. 6 may be either separate physical units, or they may be logical units in a memory system (130) or other sources of stored information, such as elements 117-124.

Referring to FIG. 6, controller (102), in one embodiment, includes CPU (110), one or more data buffers (106′), one or more caches (108′), and a memory system (130′). The function of buffer (106′) is similar to that of buffer (106). Accordingly, buffers (106′) can interface the memory system (130′) to the holographic drive 104. Buffer (106′) receive the data or information from memory system (130′) and then alters the format of the data, if needed, to make it suitably readable or usable for the holographic drive (104). In this manner, data buffer (106′) facilitates transferring the data to drive (104) at a rate which drive (104) is capable of reading and/or writing to a holographic recording medium. Buffer (106′) can be a stand-alone unit within controller (102), or can reside in memory system (130′). Alternatively, data buffer 106′ can reside in drive (104) in conjunction with data buffer (106). In this manner, access to data from memory system (130) to or from drive (104) is improved.

Cache device 108′ can be a separate physical unit within controller (102), or can be a logical unit located in memory system (130′) or drive (104), or both. Cache device (108′), independently or in conjunction with data buffer (106′), can operate to substantially optimize the delivery of the data to and from drive (104).

Drive (104) can accommodate different types of holographic recording media. For instance, the holographic recording medium may be a disk or card.

Referring now to FIG. 5, in certain embodiments, holographic drive (123) or holographic drive (124) and drive (104) can include one or more holographic disk or card drives. Drive (104) and drive (123) can record holograms on one or more tracks of the disk or card. In the case of drive (104), the information recorded as holograms on one or more tracks can be recorded in a manner such that the multiplexing number and/or the areal storage density is not restricted or limited by the Bragg method (explained above) and/or restrictions or limitations related to use of the full Nyquist aperture or larger aperture (explained above). The tracks refer to the arrangement of storage location areas of holographic recording in concentric paths, helical paths, rows and/or columns, and the like, that optionally may be staggered in one or more directions with respect to the storage location areas, or can be in other suitable paths. Further, the arrangement of areas of holographic recording along the tracks about the total recording area of the disk or card can be abutting, separated, or partially overlapped along the said paths, or fully overlapped within regions of the path such that the regions can be abutting, separated, staggered or partially overlapped along the path, or combinations thereof. In addition, the arrangement of the tracks can be abutting, separated, staggered in one or more directions or partially overlapped, or combinations thereof. Further, the disks or cards can be stored, for example, in a jukebox arrangement in a light-tight storage device or subsystem, which may include one or more cartridges, and, alternatively, after recording is completed said disks or cards can be stored in a non-light-tight storage device which also may include one or more cartridges. The light-tight storage device may be a cartridge containing the holographic medium.

The elements of the devices schematically shown in FIG. 5 and FIG. 6 interface with each other by electronic and/or optical communication means that may include wire or fiber or may be wireless.

### Devices Suitable for Content-Searching

In order to implement content-searching, devices and methods described in a co-pending patent application, filed on an even date herewith under the attorney docket number 3174.1027-002 can be used. The entire teachings of the co-pending application are hereby incorporated by reference.

One embodiment of a holographic drive suitable to practice content-searching is shown in FIG. 7. Specifically, FIG. 7 is a schematic diagram of one embodiment of an apparatus suitable for practicing the present invention which can accomplish writing and/or reading to or from a holographic recording media (HRM), as well as content-searching holographically stored information recorded in an HRM. The device shown in FIG. 7 comprises SLM 1, lens elements 2 and 3, readout detector 4 for detecting reproduced holograms, optical element 32 (which can be a reflector or a mirror, e.g., an ellipsoidal mirror), and correlation detector 55. Lens elements 2 and 3 can each include one or more lenses or any other optical elements suitable for refracting, reflecting or diffracting light beams. Further, optical axis (25) may be folded to provide for further compactness of the optical system or for other desirable features such as incorporation of optical relay systems, in which case, for example, the optical axis of lens element (2) may be folded so as to be oriented at an angle of 90 degrees from the optical axis of lens element (3) and may be folded again if desirable for the optical system. Also shown in FIG. 7 is HRM 5 which includes a first aperture element 15, depicted as a front aperture element, a second aperture element 16, depicted as a rear aperture element, and recording material 8. First aperture element 15 and second aperture element 16 can include a reflecting surface.

FIG. 7 schematic represents all three possible modes of operation of the device shown. In a writing (recording mode), beam 19 is encoded by SLM (1) into encoded Object beam (20), which can also be a search argument beam during searching operations. Object beam (20) intersects and overlaps with a coherent Reference beam (10), that is at an angle θ with respect to optical axis (25), at the recording material (8) of HRM (5). Any known method of holographic image multiplexing can be employed during the recording operation, which, by way of example, can be multiplexing methods such as shift, planar-angle, azimuthal (peristrophic), out-of-plane tilt, wavelength, phase, spatial, or combinations thereof. In a reading mode, Reference beam (10) is directed at HRM (5), thereby generating reconstructed Object beam 20′, relayed or imaged at readout detector (4) by lens element (3). Optical element (32) and aperture element (16) are depicted in the said writing and/or reading embodiments to reflect the transmitted or undiffracted Reference beam (10′) light, respectively, such that it can exit the optical system during recording or reading operations, or otherwise not be propagated by lens element (3) to detector (4) during reading operations. In another embodiment, rear surface 161 of the rear aperture element (16) may be blackened or otherwise darkened to prevent said light (10′) from entering media (5) or from being propagated by lens element (3) to detector (4). In these embodiments it is preferable that the said transmitted or undiffracted Reference beam (10′) not impinge upon the media (5) so as to re-enter the recording material (8) or be redirected into the detector (4). Finally, in a content-search mode, encoded beam 20 is a search-argument beam, which generates correlation signal beam 10′ upon diffracting on a hologram recorded in HRM 5. Correlation signal beam 10′ reflects off of optical element (reflector) 32, is redirected to second aperture element 16, which, in the embodiment shown, includes a reflector, and is directed at correlation detector 55.

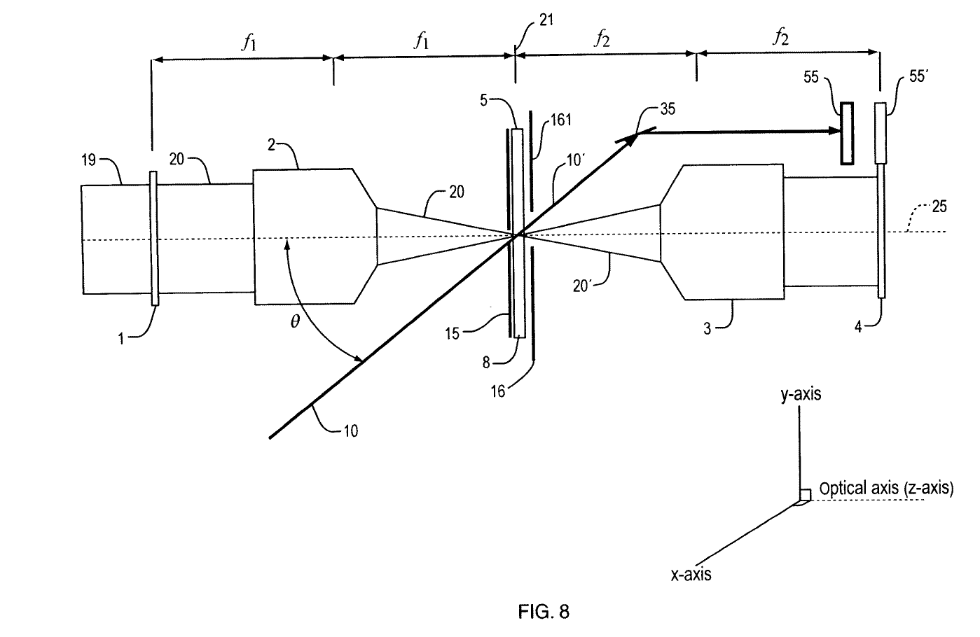

An alternative embodiment of a device of the present invention is shown in FIG. 8. This embodiment includes a flip mirror 35. Flip mirror 35, can be mounted directly behind HRM 5 along the line of the forward-propagating direction of Reference beam 10 (i.e. beam 10′) Flip mirror 35 operates to redirecting the correlation signal beams to a correlation signal detector 55. Flip mirror 35, by way of example, can be a flat reflector surface, or curved reflector surface, or can comprise a grouping of segmented facets that are each reflecting surfaces and can have inclination angles with respect to a flat surface. Flip mirror 35 can be moved by actuator or other motive device or otherwise operated to be positioned into a reflecting position for redirecting correlation signal beams to correlation detector 55 during searching operation.

Alternatively, and still referring to FIG. 8, correlation signal detector 55′ can be used instead of correlation detector 55. Correlation detector 55′ is disposed alongside readout detector 4 and is an extension of readout detector 4, as shown schematically in FIG. 8. Thus, correlation signal detector 55′ and readout detector 4 may be integrated into a larger detector element. This larger detector element can comprise detector elements for reading operations and, separately, detector elements for searching operations, wherein the types and/or shapes of detector elements for the two operations may be different.

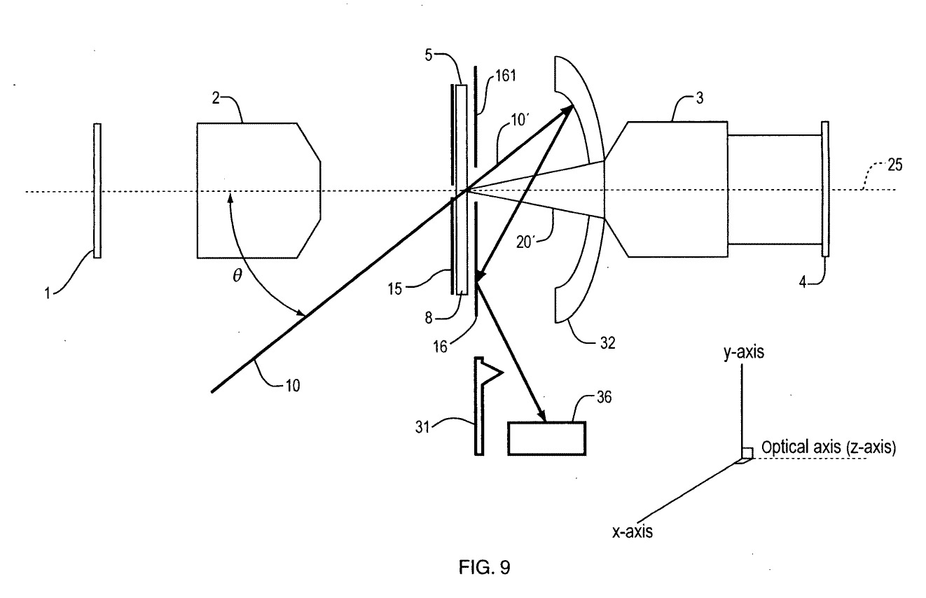

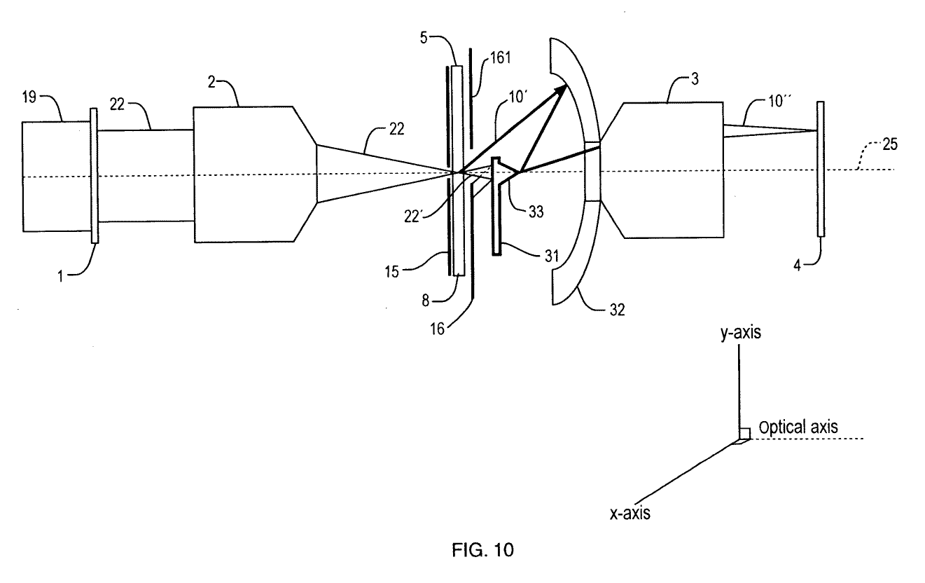

FIG. 9 and FIG. 10 are a schematic diagrams of another embodiment of a device of the present invention that can be used for reading, writing, or content-searching holographically stored information. The device shown in FIG. 9 and FIG. 10 can employ a single detector to both detect a reconstructed holographic image and to detect one or more correlation signals.

The device shown in FIG. 9 and FIG. 10 comprises SLM 1, lens elements 2 and 3, readout detector 4 for detecting reproduced holograms, and optical element 32 (which can be a reflector or a mirror, e.g., an ellipsoidal mirror). Also shown is beam dump 36. Optical element 31, which can be a reflector (a mirror) is movable and can be slidably disposed in the optical path of beam 20 and/or reflected portions of beam 10′. (See below the discussion of FIG. 10 for more details.) Lens elements 2 and 3 can each include one or more lenses or any other optical elements suitable for refracting, reflecting or diffracting light beams. Also shown in FIG. 9 and FIG. 10 is HRM 5 which includes a first aperture element 15, a second aperture element 16, and recording material 8. Second aperture element 16 can include a reflecting surface.

FIG. 9 illustrates the use of the depicted device in the reading operation mode. It is understood that the reading operation mode can be employed to read holographic holographically stored information recorded using various multiplexing methods or combinations thereof. As shown, Reference beam 10 is directed at HRM 5 at an angle θ to optical axis of 25 of the device, thereby generating reconstructed object beam 20′, which is relayed to detector 4 by lens element 3. Undiffracted Reference beam 10′ is reflected from optical element (mirror) 32, is thereby redirected at second aperture element 16, which, in the embodiment shown, includes a reflector, and is then directed at beam dump 36. As seen in FIG. 9, movable element 31 is positioned to allow reconstructed beam 20′ or undiffracted beam 10′ to reach detector 4 or beam dump 36, respectively. Alternatively, second aperture element 16 can comprise the beam dump, in which case, it does not operate to redirect the once reflected light from optical element 32.

FIG. 10 illustrates the use of the same device for operation of content searching mode (also referred to as “address retrieval mode”). SLM 1 encodes beam 19, thereby generating a search argument beam 22. Search argument beam 22 is relayed by lens element 2 at a selected storage location in HRM 5 having holographically stored information. In case of a successful search operation, search argument beam 22 at least partially diffracts, thereby creating correlation signal beam 10′. The undiffracted portion of search argument beam 22, shown as beam 22′, passes through HRM 5 and is blocked from propagating toward detector 4 by optical element 31. As shown in FIG. 10, and especially when compared to FIG. 9, element 31 can be moved into the optical path of search argument beam 22 (and, correspondingly, into the optical path of undiffracted portion 22′ of beam 22) during the search mode operation. A group of correlation signals 10′, generated by the correlation of the image of search argument beam 22 with the holographically stored information content in a group of multiplexed holograms stored in a selected storage location, can be relayed simultaneously by lens element (3) to detector (4) as a group of beams 10″. Thus, a parallel search of holographically stored information with search argument beam 22 is provided.

Referring to FIG. 10, the diffracted portion of search argument beam 22 is shown as correlation signal beam 10′. Correlation signal beam 10′ is directed at reflector 32 (shown in FIG. 10 as an ellipsoidal mirror) and is then redirected at element 31. Element 31 includes reflector 33 that is configured to redirect correlation signal beam 10′ at lens element 3. Lens element 3, in turn, relays correlation signal beam 10′ (as beam 10″) to detector 4. In certain embodiments, reflector element (32) can be rotated or tilted slightly when in the Address Retrieval (i.e. content-search) mode, thereby providing for the correlation signal beam to be directed towards reflective element (31).

Another embodiment of a device that can be used to practice the present invention is shown schematically in FIG. 11. The device of FIG. 11 is similar to the device shown in FIG. 9 and FIG. 10 and comprises SLM 1 that encodes beam 19, thereby generating a search argument beam 22. Search argument beam 22 is directed by lens element 2 at HRM 5. In case of a successful search operation, search argument beam 22 partially diffracts by interaction with HRM 5, thereby creating correlation signal beam 10′. The undiffracted portion of search argument beam 22, shown as beam 22′, passes through HRM 5, and is blocked from propagating toward detector 4 by optical element 31. As shown in FIG. 11, element 31 can be moved into the optical path of search argument beam 22 (and, correspondingly, into the optical path of undiffracted portion 22′ of search argument beam 22). The diffracted portion of search argument beam 22 is shown as correlation signal beam 10′. Correlation beam 10′ is directed at reflector 32 and is then redirected at element 31.

Unlike reflective element of FIG. 9 or FIG. 10, reflective element 32 shown in FIG. 11 is a flat or segmented mirror. Reflective element 32 of FIG. 11 can be rotated or tilted to accommodate correlation signal beams 10′ generated during content search operations of holographically stored information recorded using various multiplexing techniques. For example, the reflective surface (33) and the reflective element (32) each comprise planar surfaces that are shown as inclined with respect to the optical axis (25), such as can be used for dual multiplexed holograms recorded co-locationally in a storage location using planar-angle in combination with tilt multiplexing methods. A group of correlation signals 10′, generated by the correlation of the image of search argument beam 22 with the holographically stored information in a group of multiplexed holograms in a selected storage location in HRM 5, can be relayed simultaneously by lens element (3) to detector (4) as a group of beams 10″, thereby providing for parallel search of the holographically stored information with search argument beam 22.

In certain embodiments, element 31 includes reflector 33 that is configured to redirect correlation signal beam 10′ at lens element 3. Lens element 3, in turn, relays correlation signal beam 10′ to detector 4.

In one embodiment of the devices shown in FIG. 9, FIG. 10 and FIG. 11, namely when f1=f2, optical elements (31) and (32) may be combined into one optical element

In the embodiments shown in FIG. 7 and FIG. 9, elements (32) and (31) (see FIG. 9) are mirrors. In these embodiments, the devices shown include lens elements (2) and (3), which may each comprise a grouping of optical components (i.e. elements) and may optionally be coated for anti reflection properties, wherein the numerical aperture of lens elements (2) and (3) are typically in the range of about 0.2 to 0.8. Further, optical axis (25) may be folded to provide for further compactness of the optical system or for other desirable features such as to incorporate optical relay systems, in which case, by way of example, the optical axis of lens element (2) may be folded so as to be oriented at an angle of 90 degrees from the optical axis of lens element (3) and may be folded again if desirable for the optical system.

The recording material (8) in media (5), shown in FIG. 7 and FIG. 9, is positioned between lens elements (2) and (3) at a distance of focal length f₁ and f₂ from each, respectively, wherein f₁=f₂ for a 4-f optical system and said recording material (8) is shown to be located at the Fourier transform plane (21) of lens element (2). Alternatively, the recording material (8) may be located at intermediate distances from the Fourier transform plane of lens element (2), such as for recording at fractional Fourier transform planes. Additionally, the media (5) may be rotated about the shown y-axis to angles such that the recording plane of the media (5) is non parallel to the x-y plane and non perpendicular to the optical axis (25), such as for purposes of reducing the slant angle of recorded holograms.

Preferred embodiments may feature a 4-f type optical recording/reading geometry for 1:1 imaging that utilizes dual multiplexing methods comprising, by way of example, planar-angle and azimuthal multiplexing or planar-angle and tilt (out-of-plane angle) multiplexing. Other optical recording/reading geometries are also contemplated, such as 6-f or 8-f optical recording/reading systems or the like that may be used for improved Signal-to-Noise (SNR) for content retrieval (see Waldman and Butler in WO 2004/112045 A2, the entire teachings of which are incorporated herein) or others that are non 4-f (i.e. f1≠f2) and which, by way of example, can provide for magnification or demagnification that may be used to match pixel dimensions corresponding to one or more pixels of the SLM to pixel dimensions of one or more pixels of the digital detector (i.e. CMOS), or phase conjugate systems, and the like.

The introduction of said additional optical elements (31) and (32) (FIG. 9) can be used to modify the traditional 4-f optical recording/reading geometry such as depicted in FIG. 2 so as to operate in three distinct modes: Recording mode, Address Retrieval mode (i.e. content-based search or “content search”), and Content Retrieval mode (i.e. address-based search).

The Recording (or write) mode provides for the recording of object information or data in a holographic media (5) shown in FIG. 9 and is also applicable to the device shown in FIG. 7. Recording is carried out by presenting the media with an encoded Object beam (20), propagated by lens element (2) from SLM (1), and a Reference beam (10), also from a light source such as a laser (not shown). Reference beam (10) is shown to be incident at an oblique external angle θ with respect to optical axis (25) of the depicted 4-f system, said Object and Reference beams are substantially coherent and are directed to the media so as to overlap in the volume of the recording location and thereby form an interference pattern in said volume. The holographic recording media (5) records the interference pattern of the two said coherent beams in the volume of the recording location where the said coherent beams overlap. Turning now to FIG. 9, optical element (31) of the present invention is not present in the optical path while the system operates in Recording mode but can be moved in or out of the optical path for different operating modes of the system.

Referring now to FIG. 7 and FIG. 9, in one embodiment, optical element (32) is a reflector that may or may not be present during Recording mode. The construction and placement of optical element (32) should preferably not interfere with recording of holograms in the traditional 4-f geometry or other suitable optical recording geometries. Preferred embodiments provide for the Reference beam (10) to escape the optical system once it has passed through HRM (5) during Recording mode, and, consequently, the construction and placement of optical element (32) should provide for ability of Reference beam (10) to exit from the optical system during Recording mode. In one embodiment of the present invention, said exit of the reference beam (10) during recording is provided by the use of a rear (second) aperture element (16) located at or near the rear surface of the media (5). In this manner, by way of example, the undiffracted reference beam 10′ (see FIG. 9) is reflected from optical element (32) and becomes incident on the rear surface of the rear aperture element (16). The rear surface of aperture element (16) reflects the light at an angle such that the undiffracted Reference beam 10′ light can exit the system during recording or otherwise not be propagated by lens element (3) to detector (4).

In another embodiment of a device shown in FIG. 9, beam dump 36 can be eliminated. In such an embodiment, the rear surface of the rear (second) aperture element (16) may be blackened or otherwise darkened to prevent undiffracted beam 10′ from entering recording material (8) of media (5) or from being propagated by lens element (3) to camera (4).

In other contemplated embodiments, undiffracted reference beam 10′ may reflect from optical element (32) to aperture element (16), or to or to another light absorbing element located between reflector (32) and media (5), such that (16) or the alternative light absorbing element can operate to absorb the light or otherwise prevent it from re-entering the recording material (8) of media (5).

Still referring to FIG. 9, second aperture element (16) or the) or the light absorbing element may alternatively be integral to the media, such as a layer or surface of the media that may, by way of example, be electrically or magnetically active, such as due to an electroclinic effect from a surface or intermediate layer, and may be addressable for different locations across the area of the media. In these embodiments it is preferable that the undiffracted reference beam 10′ not impinge upon the media (5) so as to re-enter the recording material or be redirected into the detector (4).

In a further embodiment, the reflective optical element (32) may be constructed with apertures. The placement, size, and shape of the apertures in reflective optical element (32) can be determined by the angle of the incident Reference beam (10) for all multiplexed holograms. The apertures provide for the undiffracted Reference beam 10′ to exit the system during Recording mode or otherwise not be propagated or redirected by lens element (3) to detector (4).

In one embodiment, shown specifically on FIG. 9, undiffracted beam 10′ can be collected by a beam trap 36.

FIG. 9 depicts the optical paths of the beams as they appear during the operation of the shown device in the reading mode (also known as Content-Retrieval mode). (FIG. 7 shows a device having a similar optical architecture.) Referring to FIG. 9, for the embodiment of planar-angle multiplexing, the reference beam (10) is incident on the media (5) at a storage location at an incident angle θ, with respect to optical axis (25), consistent with the incident angle of the Reference beam (10) during recording of the one or more holograms in the storage location. The Reference beam angle θ during Recording mode may be different for each hologram recorded in a storage location such as for the case of planer-angle multiplexing. In such cases the Reference beam angle θ during Content Retrieval mode will also be different for each different hologram reconstructed in said storage location. In other cases the Reference beam angle θ during Content Retrieval mode may not be different for each hologram recorded in a storage location, such as when dual multiplexing methods are used. The Reference beam angle θ during Content Retrieval mode may be adjusted to optimally achieve the Bragg condition, so as to compensate for (i) volume shrinkage of the holograms such as may occur for holograms recorded in photopolymerizable materials or (ii) temperature changes between when the hologram(s) was recorded and reconstructed for Content retrieval or (iii) change in wavelength of the laser from the wavelength at the time of recording the hologram(s), or change in tilt of the media with respect to the Reference beam (10) at the time of recording the hologram(s) such as may occur when the media is removable from the system, or combinations thereof. The reference wave diffracts from the Bragg-matched grating in the holographic media thereby reconstructing the Fourier spectrum of the recorded object. The Fourier spectrum is inverse Fourier transformed by lens element (3), thereby directing the reconstruction image onto the detector plane (4). The requirements for optical elements (31) and (32) can be identical to the requirements stated above for the recording mode.

During the Content-Searching mode (also referred to as “Address Retrieval mode”) of operation optical elements (31) and (32) are both inserted into the optical train used for holographic data storage as shown, by way of example, in FIG. 10. Address Retrieval is implemented by presenting a storage location(s) in the media with a search argument propagated by lens element (2) from SLM (1). The search argument is encoded by SLM (1) and depicted as bounded by ray bundle (22) in FIG. 10. The search argument encoded by the SLM (1) may comprise a grouping of pixels arranged in a contiguous manner over an array equal to the entire SLM array size of m rows by n columns of the m×n SLM. Alternatively, the search argument may comprise a grouping of contiguous pixels arranged in an area that is less than the entire m×n array size of the SLM, such as depicted by bounded rays (22) in FIG. 10. In this embodiment, the pixels may be arranged in a contiguous manner in complete rows or columns but in fewer than m rows and/or n columns, or, alternatively, may be arranged in a contiguous manner but in incomplete rows and columns. In another embodiment, the search argument encoded by m×n SLM (1) may comprise a grouping of pixels arranged in a non-contiguous manner.

The smallest area fraction of the m×n array size of SLM (1) that may be used for the search argument can be influenced by the manner in which the holograms are recorded, for example amplitude-modulated holograms and phase modulated holograms may have different size of the smallest area of the search argument usable for content searching mode of operation. Likewise, the resultant signal-to-noise characteristics of the cross-correlation noise, as well as the multiplexing methods used in recording also affect the smallest usable area of the search argument usable for content searching mode of operation.

The Fourier spectrum of the search argument is formed by the transform lens element (2). The transformed image of the search argument is directed (relayed) towards a storage location on the media comprising at least one recorded hologram, wherein the at least one hologram may be located at the Fourier plane of lens element (2) or, alternatively, at a fractional Fourier plane. In a preferred embodiment, a storage location comprises a plurality of multiplexed holograms, and even more preferably a plurality of co-locationally multiplexed holograms such as by combination of planar-angle and tilt multiplexing or planar-angle and azimuthal multiplexing wherein storage locations are additionally spatially multiplexed.

Each hologram(s) in the selected storage location of the media, that is illuminated with the said image of the search argument and which comprises content correlating at least in part with the search argument, diffracts light in a direction and having a wavefront consistent with its own reference beam orientation and wavefront used during recording of the said hologram(s). An array of search generated Reference beams is produced from the multiplexed holograms when correlation of the stored information in the holograms occurs with the image of the search argument, each said search generated Reference beam(s) having intensity proportional to the extent of the correlation of the image of said search argument and the information content of the hologram(s), as well as the size of the search argument. Said array may be 1-D, such as when single multiplexing methods (e.g. planar-angle multiplexed) are used to record the holograms, or optionally may be 2-D, such as when dual multiplexing methods (see above described methods such as planer-angle in combination with azimuthal or planar-angle in combination with tilt) are used to record the holograms. In one embodiment of the current invention, such as depicted schematically in FIG. 10 for a search generated Reference beam, the said array of search generated Reference beams reflects off element (32) and is directed towards the surface of optical element (31). In said embodiment optical element (31) operates to redirect the array of search generated Reference beams through the inverse Fourier transform lens element (3) towards the detector (4). FIG. 10 shows schematically, for simplicity, one of the said array of correlation signal beams (10′) that corresponds to the correlation signal from one of the multiplexed holograms in the selected storage location, said correlation signal propagated through lens element (3) and relayed towards the detector (4) as correlation signal beams (10′). A grouping of said correlation signals, generated by the correlation of the image of the search argument with the information content in a grouping of multiplexed holograms in the selected storage location, can be propagated simultaneously through lens element (3) so as to be directed simultaneously to the detector (4).

In one embodiment, the rear surface of optical element (31) (i.e. the surface facing lens element 3) is constructed so that the array of search generated reference beams is reflected by element (31) towards lens element (3) so as to remain spatially separated and optionally focused on the detector (4). In this manner, detector (4) will detect a grouping of resolved correlation signal(s) (10′), each corresponding to a hologram recorded with a different reference beam. The spatially separated array of correlation signal beams may not all be ideally focused on detector (4). This effect is due to the increased path length resulting from introduction of optical elements (31) and (32) into the optical configuration. However, all beams in such an array will intersect the detection plane of detector (4). In this manner, a plurality of correlation signal beams, diffracted from a storage location having a large multiplexing factor for its recorded holograms, can all be simultaneously detected using one short-time pulse of light, such as from a pulsed laser. Thus permits achieving rapid data search rates for content of the stored multiplexed holograms.

The rear surface of optical element (31) (i.e. the surface facing lens element 3) can include a reflective surface (33) having curvature and can be contiguous or segmented. Segmented surface is preferred for the apparatus of the present invention for dual multiplexed holograms recorded co-locationally in a storage location using planar-angle in combination with azimuthal multiplexing methods.

Preferably, reflective surface (33) is a surface having curvature when reflective element (32) comprises a surface having curvature, or said surface (33) is a surface having a grouping of surfaces each having curvature when reflective element (32) comprises a surface having curvature, or said surface (33) comprises a grouping of planar surfaces on a surface having curvature when said element (32) comprises a segmented surface having a grouping of planar surfaces on a surface having curvature, or said surface (33) is a planar surface when said element (32) comprises a planar surface. By way of example, reflective surface (33) can be a convex or concave curved surface or aspherical surface when reflective element (32) comprises a concave elliptical surface or ashperical surface.

The correlation signal beams (10′) directed from reflective element (32) having concave elliptical surface will focus at a position(s) located prior to focal position F2 of the elliptical surface, namely before reflective surface (33), wherein the distance between the focus position of the said Reference beam(s) (10′) and position F2 is dependent upon planar angle θ (i.e. larger planar angles θ will exhibit larger divergence at F2; see Waldman et al. in WO 2004/0066035 A2, the entire teachings of which are incorporated herein). In a further preferred embodiment, reflective surface (33) is a segmented surface having a grouping of concave curvatures so as to compensate for divergence of search generated Reference beam(s) (10′) incident upon reflective surface (33) of optical element (31) at position F2 from reflective element (32) having ellipsoidal surface, thereby providing a means to redirect and focus Reference beam(s) (10′) onto detector (4).

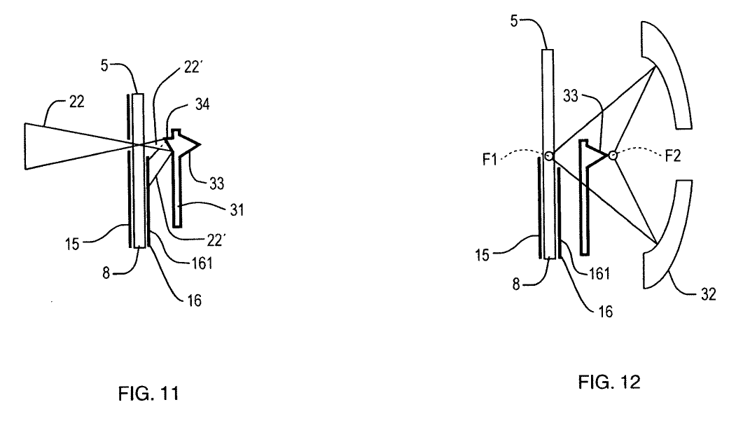

In another embodiment, shown in FIG. 11, the front surface 34 of optical element (31) that is behind and adjacent to media (5) preferably also operates to deflect or otherwise redirect the undiffracted object beam (22′) towards the rear surface 161 of aperture element (16). In this manner the undiffracted object beam (22′) can exit the system during Address Retrieval (. e. content search) mode, or otherwise not be propagated by lens element (3) to detector (4). Rear surface 161 of aperture element 16 can be a light absorbing or light trapping surface that operates to absorb or trap the undiffracted object beam (22′). Alternatively, aperture element 16 can be reflective and thereby can direct the undiffracted object beam (22′) to another light absorbing element, (not shown in FIG. 12) that similarly operates to absorb or trap the undiffracted object beam light (22′).

Referring now to FIG. 12, in another embodiment of an apparatus for content-searching of holograms recorded using dual multiplexing, such as comprising planar-angle and azimuthal methods, the inner surface of reflective element (32) preferably has two focal positions. The first focal position (F1) is located in the media at or near the recording plane, and the second focal position (F2) is located in the vicinity of reflective surface (33) such that the array of correlation signal beams are reflected so as to be spatially separated and focused on the detector (4) (not shown in FIG. 12). The exact position of the second focal position F2 depends upon the structure of the rear reflective surface of optical element (31). A preferred embodiment of the reflector element (32) having two focal positions, is depicted in FIG. 12. The ellipsoidal surface of element 32 may be contiguous, as shown, or alternatively segmented having a grouping of planar surfaces on a surface having curvature. In this manner, correlation signal beam (10′) can be redirected by reflective element (32) towards its focal position F2 and onto reflective surface (33), and then be redirected towards lens element (3) so as to be focused on detector (4) as correlation signal (10″). When reflector element (32) having two focal positions is a segmented elliptical surface comprising a grouping of planar surfaces, then reflective surface (33) can comprise a grouping of planar surfaces oriented so as to be inclined with respect to the optical axis (25).

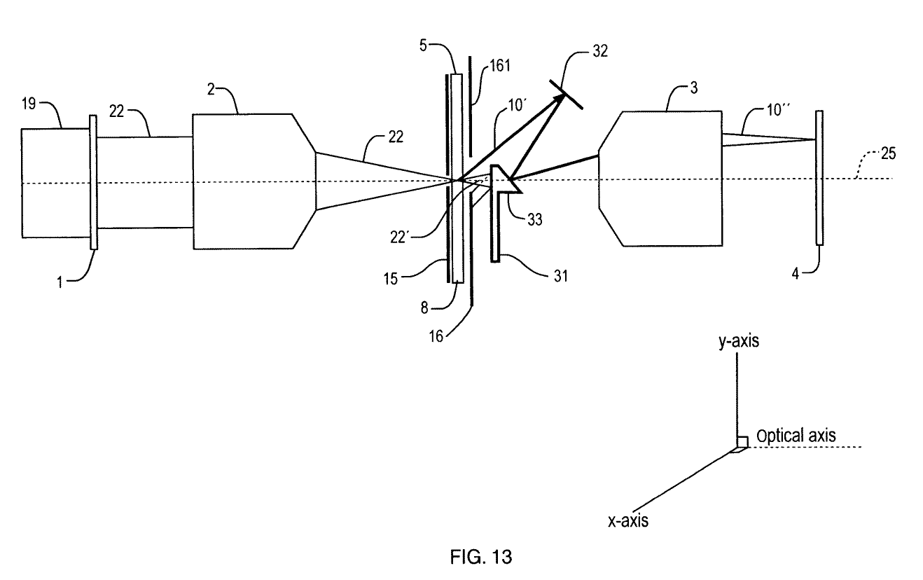

In still another embodiment, shown in FIG. 13, reflector element (32) comprises a planar surface and reflective surface (33) can comprise a planar surface that is inclined with respect to optical axis (25), such as can be used for dual multiplexed holograms recorded co-locationally in a storage location using planar-angle in combination with tilt multiplexing methods.

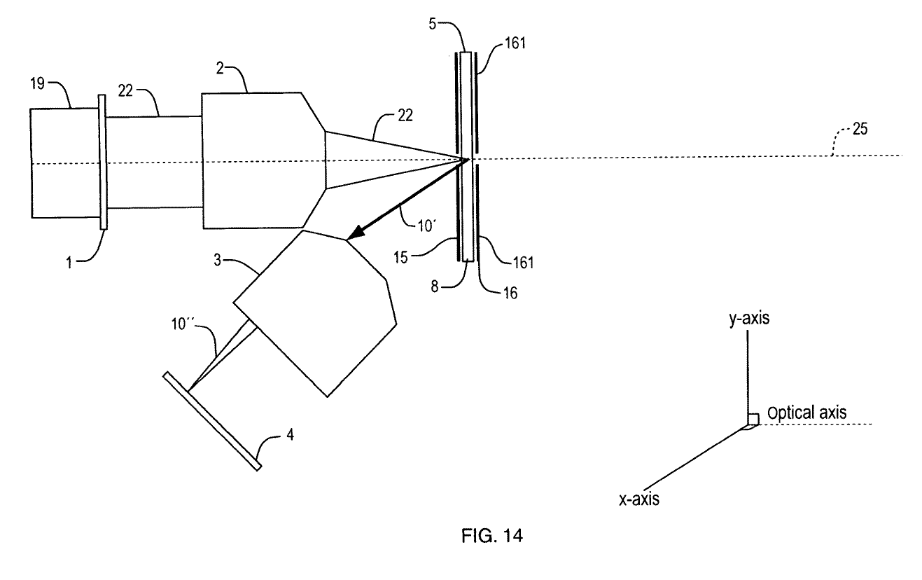

FIG. 14 depicts schematically an embodiment of an apparatus and method of the present invention wherein the detector (4) can be used for the Address Retrieval (content-searching) of stored holograms to detect one or more correlation signal (10″). FIG. 14 depicts schematically an embodiment in which the multiplexed holograms in media (5) are recorded as reflection holograms. Correlation signal beam (10′) generated by diffraction of search argument beam 22 from one of the multiplexed reflection holograms in the selected storage location on media (5) is diffracted towards lens element (3) and propagated through lens element (3) as 10″ so as to be spatially separated and optionally focused on the detector (4). It is understood that correlation signal beam 10″ can be one of a grouping of resolved correlation signals, each corresponding to a hologram recorded with a different reference beam, said hologram generating a non-zero correlation signal. First aperture element (15) can be optionally included and second aperture element (16) may be excluded. In an alternative embodiment, lens element (3) can be removed and correlation-signal beam (10″) can propagate directly to detector (4). In yet another embodiment, correlation-signal beam (10″) can propagate to a lenslet array positioned in front of detector (4) or integrated with detector (4) so as to be spatially separated and/or optionally focused on the detector (4). Alternatively, lens element (3) can be a Fresnel lens element that comprises an annulus region, wherein the correlation signal beams from the multiplexed holograms in the selected storage location in media (5) are incident upon the annulus region so as to be spatially separated and optionally focused on the detector (4) as one of a grouping of resolved correlation signal(s) (10″), each corresponding to a hologram recorded with a different reference beam that may, by way of example, correspond to planar-angle and azimuthal or planar-angle and tilt multiplexed holograms.

Lens element (3) can additionally be replaced with one or more prisms or other refractive optical element, such as an element comprising one or more surfaces having facets, that is rotatable through an angular range by a motive device about an axis parallel or coincident with the optical axis of the array of correlation signal beams (10″). Such a rotatable refractive optical element can redirect the array of correlation signal beams (10′) originating from multiplexed holograms recorded using different tilt or azimuthal angles to detector (4) as spatially resolved correlation signal beams (10″).

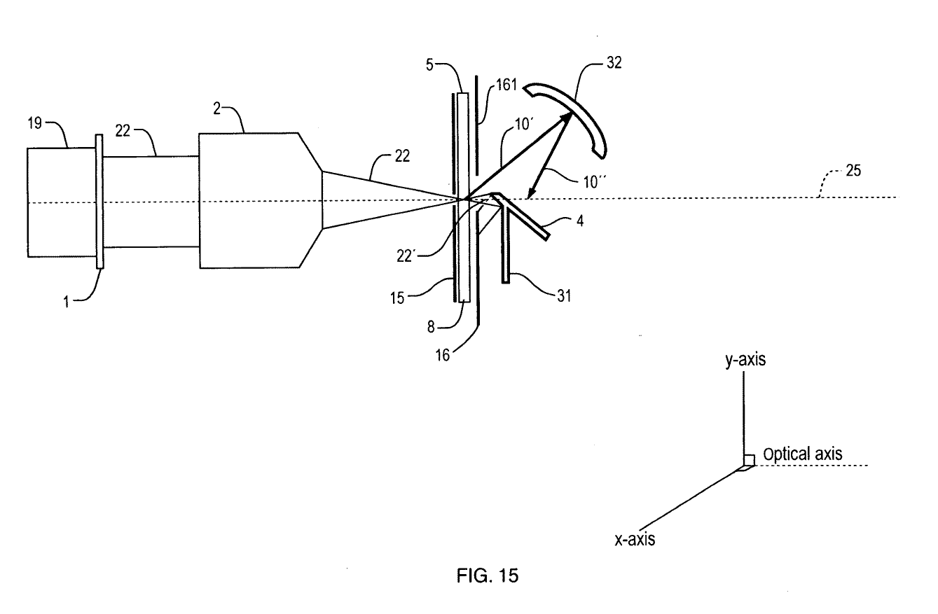

FIG. 15 depicts schematically an embodiment of an apparatus that can be used to practice the present invention. In FIG. 15, one correlation signal beam (10′) out of an array of such beams, each beam 10′ corresponding to a multiplexed hologram in the selected storage location in media (5) that generates a non-zero correlation signal, is shown to be redirected by reflector element (32) as correlation signal beam 10″ towards detector 4. Reflector element 32 preferably has a concave elliptical reflecting surface 321. Alternatively, surface 321 can be a segmented surface having a group of reflective elements each having concave curvature. As a result, the array of beams 10′ is spatially separated and optionally focused by element (32) as an array of correlation signal beams 10″ on the detector (4). In this embodiment, detector (4) is positioned behind media (5), at or near the focus position of reflective element (32), whereas a dedicated lens element used for directing correlation signal beam at detector 4 (shown in FIG. 7-10, 13 and 14) is not present. Similarly, the undiffracted object beam (22′) can exit the system during content searching operation. Optionally, reflector element (31) can be used to redirect undiffracted object beam (22′) to second aperture element (16), where it can be blocked, absorbed or redirected away from media (5) or to a beam dump (not shown).

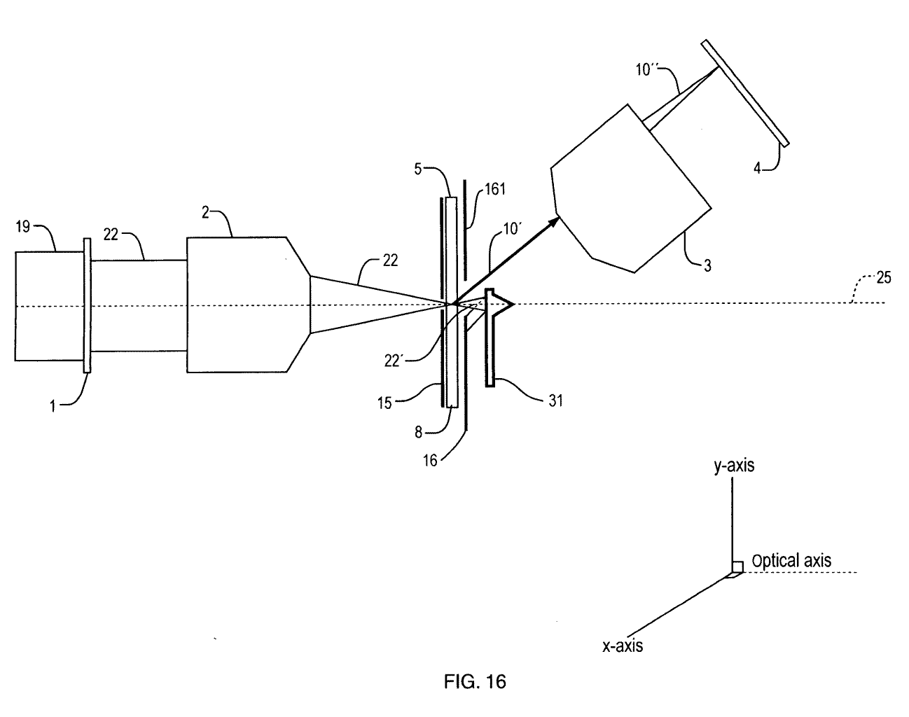

FIG. 16 depicts schematically an embodiment of an apparatus that can be used to practice the present invention. In FIG. 16, one correlation signal beam 10′ out of an array of beams (10′), each corresponding to a correlation signal from one of the multiplexed holograms in the selected storage location in media (5) that generates a non-zero correlation signal, is shown to be directly incident upon lens element (3) so as to be spatially separated and optionally focused as correlation signal beams 10″ on the detector (4). The undiffracted object beam (22′) can exit the system during Address Retrieval (content searching) operation. Optionally, reflector element (31) can be used to redirect undiffracted object beam (22′) to second aperture element (16), where it can be blocked, absorbed or redirected away from media (5) or to a beam dump (not shown). In an alternative embodiment, lens element (3) can be removed and correlation signal beams (10″) can propagate directly to detector (4). Alternatively, correlation signal beams (10″) can propagate directly to a lenslet array positioned in front of detector (4) or integrated with detector (4) so as to spatially separated and/or optionally focus the array of correlation signal beams 10″ on the detector (4). Alternatively, lens element (3) can be a Fresnel lens element that comprises an annulus region, wherein the correlation signal beams from the multiplexed holograms in the selected storage location in media (5) are incident upon the annulus region so as to be spatially separated and optionally focused on the detector (4).

Lens element (3) can additionally be replaced with one or more prisms or other refractive optical element (not shown), such as an element comprising one or more surfaces having facets, that is rotatable through an angular range by a motive device about an axis parallel to or coincident with the optical axis of the array of correlation signal beams (10″). Such a rotatable refractive optical element can redirect the array of correlation signal beams (10′) originating from multiplexed holograms recorded using different tilt or azimuthal angles to detector (4) as spatially resolved correlation signal beams (10″).

Detectors suitable for use in the practice of the present invention (e.g. detectors 4 in FIGS. 2, 7-10, 13-16, or correlation detector 55 in FIG. 8 and detector 55′ in FIG. 8) can be a 2-D detector of CMOS or CCD type, diode detectors, magneto-optical elements, or any other detector types that can be suitably arranged to rapidly resolve and detect optical signals.

### Superpixel Indexation

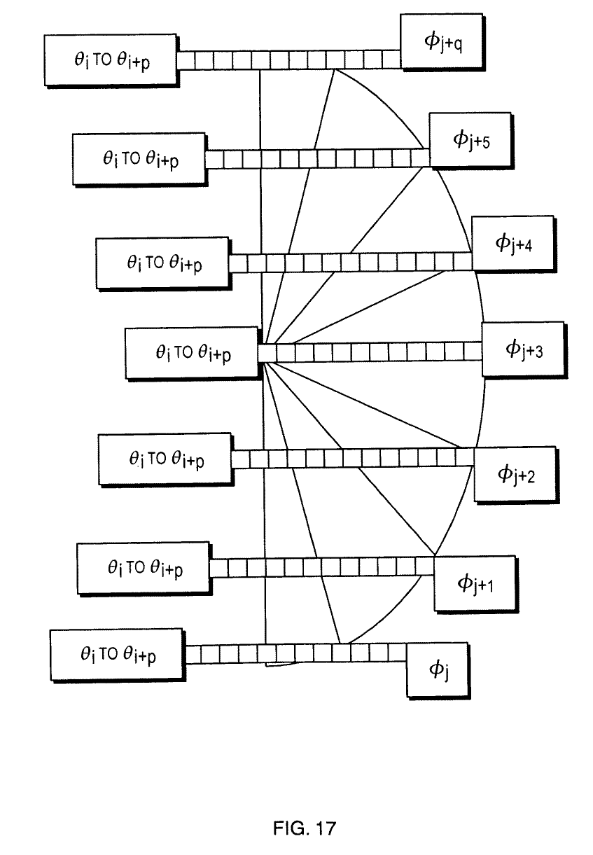

Preferably, the detector is a 2-D detector comprising an array of individual detector elements such as pixels. Groups of contiguous pixels along a row or a column can also be referred to as “superpixels”. Superpixels can also be contiguous grouping of pixels arranged into both columns and rows. In one embodiment, shown schematically in FIG. 17, each row of superpixels corresponds to a value of azimuthal or tilt multiplexing angle θ selected from a sequence φⱼ, φⱼ₊₁, φⱼ₊₂, φⱼ₊₃ . . . φ_{j+q}, and each column of superpixels corresponds to a value of planar-angle multiplexing angle θ selected from a sequence φᵢ, φᵢ₊₁, φᵢ₊₂, φᵢ₊₃ . . . φᵢ₊ₚ.

Accordingly, in one embodiment, the detector includes a plurality of indexed detector elements, each said detector element assigned a set of indices, each set of indices corresponding to a set of one or more multiplexing parameters of at least one hologram recorded in the selected storage location. The multiplexing parameters include angles, wavelengths, location shifts and any other parameter of a holographic recording that can be used for multiplexing. In certain embodiments, the methods of the present invention include detecting the correlation signal beam by the detector element having a selected set of indices; and based on the selected set of indices, computing the set of one or more multiplexing parameters of the hologram recorded in the selected storage location that corresponds to the correlation beam being detected.

### Multiplexing Techniques

The present invention can be especially advantageously used for parallel content searching of holographically stored information recorded using various multiplexing techniques. These multiplexing techniques will now be generally described.

The Reference beam (10) in FIG. 7 can be incident at an oblique angle θ with respect to optical axis (25), where θ is selected from one or more of a grouping of angles about the shown y-axis that are perpendicular to the y-axis and where the optical axis (25) is also perpendicular to the y-axis. Multiplexing of holograms in a storage location is therefore based upon selection of at least one value of the angle θ that is directed along a line on the interaction plane, said plane defined herein as containing the Reference beam (10) and the optical axis (25) of the Object beam (20). Recording a grouping of two or more holograms co-locationally, each with the Reference beam (10) at a different angle θ, is referred to as planar-angle multiplexing or in-plane angle multiplexing wherein the Reference beam (10) is a plane wave and the multiplexing is referred to as a Bragg method for which the maximum number of co-locationally recorded holograms is directly related to the thickness of the recording material (see E. N. Leith et al. in Applied Optics, Vol. 5, No. 8, pp. 1303-1311, 1966). FIG. 2 schematically depicts Δθ to represent a range of planar Reference beam angles, θ, that may be used for planar-angle multiplexing in one or more storage locations.

Alternatively, the Reference beam (10) can be incident at angles inclined (i.e. tilted out of plane) with respect to the aforementioned interaction plane defined for planar-angle multiplexing, wherein said tilted angles are directed along a line on a plane that is perpendicular to the said interaction plane and said angles are selected from one or more of a grouping of angles that are non perpendicular to the shown y-axis and thus inclined with respect to the angles selected for planar-angle multiplexing. Recording a grouping of two or more holograms in a storage location, each with a plane wave Reference beam having different tilt angle, is sometimes referred to as tilt multiplexing or out-of-plane angle multiplexing or fractal-space multiplexing (see Holographic Data Storage, eds. H. J. Coufal, D. Psaltis, G. T. Sincerbox, Chapter 2 “Volume Holographic Multiplexing Methods”, Springer, 2000 and Mok in Optics Letters, Vol. 18, No. 11, pp. 915-917, 1993, the entire teachings of which are incorporated herein), for which the maximum number of co-locationally recorded holograms is related to the F# of the imaging system and the size of the image at the detector plane rather than the thickness of the recording material.

Still further, the Reference beam (10) can be incident at angles selected from one or more of a grouping of azimuthal angles about the shown optical axis (25), such angles being along a line on a plane that contains the optical axis (25) but where said plane is rotated about the optical axis (25) with respect to the aforementioned interaction plane. Recording a grouping of two or more holograms in a storage location, each with a plane wave Reference beam having different azimuthal angle, is sometimes referred to as peristrophic multiplexing (see Pu et al. in U.S. Pat. No. 5,483,365, the entire teachings of which are incorporated herein) or azimuthal multiplexing (see Trisnadi et al. in U.S. Pat. No. 5,638,194, the entire teachings of which are incorporated herein), for which the maximum number of co-locationally recorded holograms is primarily related to the F# of the imaging system and the size of the image at the detector plane, and to a lesser degree on thickness due to a square root dependence on thickness.

Any suitable combination of two or more techniques selected for planar-angle multiplexing, tilt angle multiplexing, or azimuthal angle multiplexing can be used. The combinations of angles in sets of pairs of angles (see Mok in Optics Letters, Vol. 18, No. 11, pp. 915-917, 1993 and Pu et al. in U.S. Pat. No. 5,483,365) is sometimes referred to as dual multiplexing methods. Such combinations of two or more angles can also include pairs of angles wherein θ is combined with a zero value of the tilt angle ψ or of the azimuthal angle φ p. Further, spatial multiplexing, wherein each storage location is shifted in its position along the media in one or more directions with respect to the other locations such that the storage locations are non overlapping, can be combined with any suitable above referred to multiplexing method or combinations of methods (see Burr et al. in Opt. Communications, Vol. 117, Nos. 1-2, pp. 49-55, 19995, and Pu and Psaltis in Applied Optics Vol. 35, No. 14, pp. 2389-2398, 1996, the entire teachings of which are incorporated herein by reference). Combinations of spatial multiplexing independently with planar-angle or tilt or azimuthal or shift mutiplexing, or wavelength mutiplexing, or phase multiplexing, or correlation multiplexing is also a dual multiplexing method, and combinations with at least two of other multiplexing methods can also be implemented.

The present invention additionally contemplates that reference beam (10) may be a spherical wave or a fan of planar-waves, in which case the term “multiplexing” means shift multiplexing and is achieved by small movements of HRM 5 relative to reference beam 10 (see G. Barbastathis et al. in Applied Optics, Vol. 35, pp. 2403-2417, 1996, the entire teachings of which are incorporated herein by reference). The positions of successively or skip sorted shift multiplexed holograms, that are immediate neighbors in their locations, are shifted in accordance with their shift Bragg selectivity so as to be substantially overlapped in one or more directions. (See Psaltis et al., U.S. Pat. Nos. 5,671,073 and 5,949,558, and Curtis et al. U.S. Pat. No. 6,614,566, all of which are hereby incorporated by reference in their entirety.) In this technique, the maximum multiplexing number is directly related to the thickness of the recording material. Shift multiplexing may be implemented in the in-plane mode or out-of-plane mode, such as described for planar-angle and tilt multiplexing, respectively, and the modes may also be combined. In a preferred embodiment of the present invention, the holograms are stored utilizing at least a dual multiplexing method to achieve advantageous large multiplexing factors, said methods, by way of example, described above.

Said at least dual multiplexed holograms may be recorded in manner such that the signal beam for recording is amplitude modulated. Alternatively, the signal beam for recording may be phase modulated, such as by 0, π phase or other suitable phase modes. While FIG. 7 depicts recording of transmission holograms, the present invention is not restricted to transmission holograms. Other suitable recording geometries are also contemplated such as for reflection holograms, wherein the Object and Reference beams are incident to the media from directions that are oriented with respect to opposing sides of the media, or for recording holograms in 90 degree geometry whereby the angle between the Object beam (20) and the Reference beam (10) is equal to 90 degrees.

In a further embodiment, dual multiplexed holograms are recorded co-locationally in storage locations that are abutting, substantially overlapping, partially overlapping, spaced apart or are disposed in the HRM by a combination of these techniques. The arrangements of the storage locations can be along arcuate tracks, wherein these tracks may be abutting, overlapping or spaced apart in a radial, helical or other suitable arrangement. Alternatively, the storage locations can be arranged in rows or columns or combinations thereof. By way of example, the dual multiplexing embodiments of planar-angle in combination with azimuthal, or planar-angle in combination with tilt, in a manner such that the multiplexed holograms are stored co-locationally, provide for a substantial advantage in search speed and efficiency. The co-locationally multiplexed holograms can be searched in parallel without physically redirecting a search argument beam or moving of the HRM.

In another embodiment, the dual multiplexed holograms are recorded co-locationally in one or more storage locations by rotation of the reference beam only (see Trisnadi et al. in U.S. Pat. No. 5,638,194 and Waldman et al. in WO 2004/0066035 A2, the entire teachings of which are incorporated herein by reference) rather than rotation of the reference beam and object beam together. In this embodiment, presenting a search argument to a storage location in HRM 5 can result in generating a correlation signal from all co-locationally recorded holograms simultaneously.

### EXEMPLIFICATION

### Example 1 Content Addressable Search of Co-Locationally Multiplexed Volume Holograms Recorded with Sub Bragg Conditions for Increments of Reference Beam Angles Used for Multiplexing

As used herein, the term “search generated reference beams” refers to a correlation signal beam, the terms “content addressable search” and “Address Retrieval” refer to content-searching, the term “Address information” refers to an address, and the term “Content information” refers to a stored information.

Binary data page volume holograms comprising page size of 750×750 pixels encoded with 6-8 modulation code having balanced “1”s and “0”s were recorded as co-locationally multiplexed volume holograms in DCE Aprilis HMD-050-G-C-400 Type D recording media having 0.4 mm thick recording material using planar-angle and tilt multiplexing methods. A Coherent Corporation Verdi V5 DPSS frequency doubled Nd:YVO4 laser, operating at 532 nm, was used as the cw light source coupled through polarization-preserving single mode fiber. The SLM used was a reflective ferroelectric liquid crystal SLM (Displaytech, model LDP-0983-HS1 LightCaster®: 1280×768 pixels, 13.2 μm pixel pitch, 90% fill factor), which was operated in binary phase (0 and π) modes by rotation of the SLM by 22.5 degrees with respect to the incident polarization direction output from a polarizing beamsplitter, or by rotation of a λ/2 waveplate positioned in front of the SLM by 11.25 degrees. A DCE Aprilis custom CMOS camera (1280×1024 pixels with ˜6 μm pitch, 17 fps, 8-bit digital output, USB2 interface) was used as a detector device. Phase mode operation was used to substantially remove the high intensity dc peak at the Fourier plane and thereby substantially homogenize the Fourier power spectrum of the Object beam at the recording plane. The Reference beam was collimated by propagation of the output of the said fiber through an achromatic doublet lens, and then further propagated through a 4f optical system comprising a mirror mounted to a rotary stage and a pair of achromatic doublet lens to the recording plane. Multiplexed holograms were recorded with the said media positioned at the Fourier transform plane.

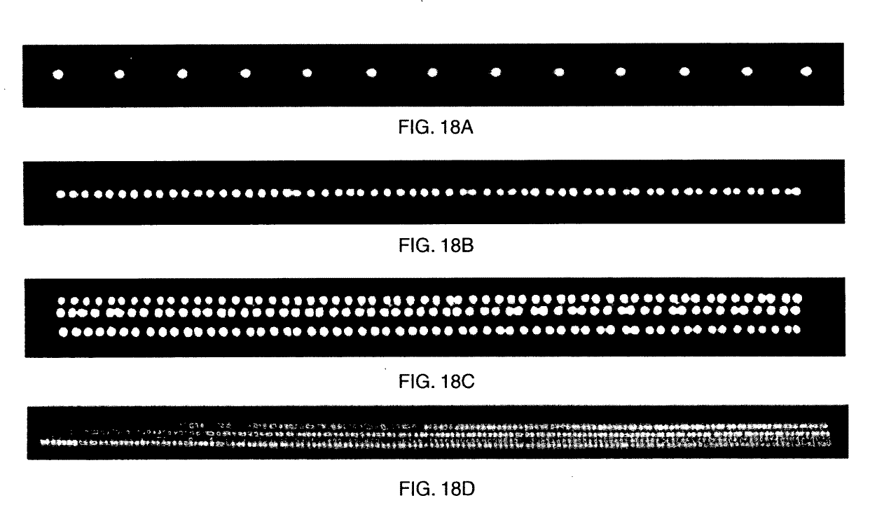

FIG. 18(a) shows simultaneous reconstruction of a grouping of Search generated reference beams generated from content addressable search of co-locationally planar-angle multiplexed holograms wheren the angle increment used for multiplexing was peak to 2^{nd} null angle spacing corresponding to 0.17° increments of the rotary stage operated to control the incident angle of the reference beam. Shown in FIG. 18(a) is a grouping of 13 Search generated reference beams originating from 13 of the plurality of co-locationally multiplexed holograms that comprised content related to the Search content of the content addressable search pattern input to the object beam. The limitation on co-locational multiplexing number in accordance with the imaging system used for the Reference beam, and in relation to the thickness of the recording material, for planar-angle multiplexing using the customary peak to 2^{nd} null angle spacing is about 30. FIG. 18(b) shows simultaneous reconstruction of a grouping of reference beams generated from content addressable search of co-locationally planar-angle multiplexed holograms, wherein the angle increment used for multiplexing was ⅕^{th} of the peak to 2^{nd} null angle spacing corresponding to 0.034° increment of the rotary stage operated to control the incident angle of the reference beam. Shown in FIG. 18(b) is a grouping of 60 simultaneous Search generated reference beams originating from 60 of the plurality of co-locationally multiplexed holograms that comprised content related to the Search content of the content addressable search pattern input to the object beam.

FIG. 18(c) shows simultaneous reconstruction of a grouping of Reference beams generated from content addressable search of the co-locationally planar-angle and tilt-angle multiplexed holograms, wherein the angle increment used for planar-angle multiplexing was ⅕^{th} of the peak to 2^{nd} null angle spacing corresponding to 0.034° increment of the rotary stage operated to control the incident angle of the Reference beam, and the angle increment for the three out-of-plane angles of the Reference beam was additionally less than peak to 1^{st} null angle spacing for the tilt multiplexing. Shown in FIG. 18(c) is a grouping of 180 simultaneous Search generated reference beams originating from 180 of the plurality of co-locationally multiplexed holograms that comprised content related to the Search content of the content addressable search pattern input to the object beam. The signal-to-noise characteristics of the said Search generated Reference beams, for holograms multiplexed using angle increments corresponding to 0.4 factor of peak to 1^{st} null, is at the A/D limit (255/1) of the CMOS camera and the resolution of the said Search generated results is clearly defined. Some of the exhibited spacings of the detected Search generated Reference beams are narrower than values corresponding to increments of 0.034° due to non optimized parameters for motion control of the stage, and thus some angle increments were even less than 0.03°.

FIG. 18(d) shows simultaneous reconstruction of a grouping of Reference beams generated from content addressable search of co-locationally planar-angle and tilt-angle multiplexed holograms, wherein the angle increment used for planar-angle multiplexing was 0.177 fraction of the peak to 2^{nd} null angle spacing corresponding to 0.030° increment of the rotary stage operated to control the incident angle of the reference beam, and the angle increment for the four out-of-plane angles of the Reference beam was additionally less than peak to 1^{st} null angle spacing for the tilt multiplexing. Shown in FIG. 18(d) is a grouping of 600 simultaneous Search generated reference beams originating from 600 of the plurality of co-locationally multiplexed holograms that comprised content related to the Search content of the content addressable search pattern input to the object beam, wherein the photograph was obtained for the ensemble of Search generated Reference beams that was propagated to a screen for viewing without further use of optics. The signal to noise characteristics of the Search generated Reference beams, for holograms multiplexed using angle increments corresponding to 0.35 factor of peak to 1^{st} null, is high and the resolution of the said Search generated results is clearly defined. Some of the exhibited spacings of the detected Search generated Reference beams are narrower than values corresponding to increments of 0.030° due to non optimized parameters for motion control of the stage, and thus some angle increments were even less than about 0.025°. The differences in intensity of the ensemble of Search generated Reference beams is a consequence of (i) the recording times used in the sequence of multiplexed co-locational recordings, as a non optimized recording schedule was implemented, and (ii) sequence of recording angles left to right in relation to the sequence of recorded holograms which impacts the effects of volume shrinkage on diffracted intensity during search reconstruction of the holograms. The multiplexing number for co-locationally recorded binary data page holograms, that can be simultaneously searched with a content addressing Search pattern, exceeded the value achievable for use of the optical system for the single method planar-angle multiplexing in recording material of 0.4 mm thickness by a factor of about 20, thus providing a means to achieve substantially increased areal storage density per unit thickness of the recording material (>450 bits/μm²) and search data rate (˜6 Gbits/sec achieved) for a holographic data storage system operable in Address Retrieval mode that generates Address information from stored holograms so as to locate, access and retrieve related Content information separately stored in other data storage systems.

### Example 2 Content Addressable Search of Co-Locationally Multiplexed Volume Holograms Recorded with Sub-Bragg Conditions for Increments of Reference Beam Angles Used for Multiplexing and Sub Nyquist Aperture for Area Exposed During Recording

As used herein, the term “search generated reference beams” refers to a correlation signal beam, the terms “content addressable search” and “Address Retrieval” refer to content-searching, the term “Address information” refers to an address, and the term “Content information” refers to a stored information.

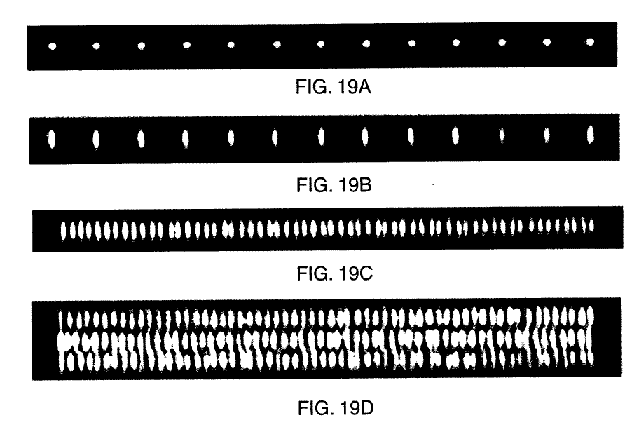

Binary data page volume holograms comprising page size of 750×750 pixels encoded with 6-8 modulation code having balanced “1”s and “0”s were recorded as co-locationally multiplexed volume holograms in DCE Aprilis HMD-050-G-C-400 Type D recording media having 0.4 mm thick recording material using planar-angle and tilt multiplexing methods as described above in Example 1. The dimension of the exposed storage location during multiplexed recording was reduced to sub Nyquist aperture by utilization of masks placed at the front surface of the media. FIG. 19(a) shows simultaneous reconstruction of a grouping of Search generated reference beams (as in Example 1; FIG. 18(a)) generated from content addressable search of co-locationally planar-angle multiplexed holograms, wherein the angle increment used for multiplexing was peak to 2^{nd} null angle spacing corresponding to 0.17° increments of the rotary stage operated to control the incident angle of the reference beam, and ˜1.2× full Nyquist aperture was used for area of the exposed storage location during multiplexed recording. FIG. 19(b) shows simultaneous reconstruction of a grouping of reference beams generated from content addressable search of co-locationally planar-angle multiplexed holograms, wherein the angle increment used for multiplexing was peak to 2^{nd} null angle spacing corresponding to 0.17° increments of the rotary stage operated to control the incident angle of the reference beam, and ˜¼ (¼ of the vertical dimension centered about the x-axis across the full horizontal dimension) of the full Nyquist aperture was used for area of the exposed storage location during multiplexed recording. Shown in FIG. 19(b) is a grouping of the 13 simultaneous Search generated reference beams as per FIG. 19(a) originating from 13 of the plurality of co-locationally multiplexed holograms that comprised content related to the Search content of the content addressable search pattern input to the object beam.

FIG. 19(c) shows simultaneous reconstruction of a grouping of reference beams generated from content addressable search of co-locationally planar-angle multiplexed holograms, wherein the angle increment used for multiplexing was ⅕^{th} of the peak to 2^{nd} null angle spacing corresponding to 0.034° increment of the rotary stage operated to control the incident angle of the reference beam, and ˜¼ (¼ of the vertical dimension centered about the x-axis across the full horizontal dimension) of the full Nyquist aperture was used for area of the exposed storage location during multiplexed recording. Shown in FIG. 19(c) is a grouping of 60 simultaneous Search generated reference beams originating from 60 of the plurality of co-locationally multiplexed holograms that comprised content related to the Search content of the content addressable search pattern input to the object beam.

FIG. 19(d) shows simultaneous reconstruction of a grouping of Reference beams generated from content addressable search of the co-locationally planar-angle and tilt-angle multiplexed holograms, wherein (i) the angle increment used for planar-angle multiplexing was ⅕^{th} of the peak to 2^{nd} null angle spacing corresponding to 0.034° increment of the rotary stage operated to control the incident angle of the Reference beam, (ii) the angle increment for the three out-of-plane angles of the Reference beam was additionally less than peak to 1^{st} null angle spacing for the tilt multiplexing and (iii) ˜¼ (¼ of the vertical dimension centered about the x-axis across the full horizontal dimension) of the full Nyquist aperture was used for area of the exposed storage location during multiplexed recording. Shown in FIG. 19(d) is a grouping of 180 simultaneous Search generated reference beams originating from 180 of the plurality of co-locationally multiplexed holograms that comprised content related to the Search content of the content addressable search pattern input to the object beam. The signal to noise characteristics of the said Search generated Reference beams, for holograms multiplexed using angle increments corresponding to 0.4 factor of peak to 1^{st} null, is at the A/D limit (255/1) of the CMOS camera and the resolution of the said Search generated results is clearly defined even with the spreading in the vertical direction due to the sub Nyquist aperture condition used for recording the holograms. Some of the exhibited spacings of the detected Search generated Reference beams are narrower than values corresponding to increments of 0.034° due to non optimized parameters for motion control of the stage, and thus some angle increments were even less than 0.03°.

Additionally, results for 600 simultaneous Search generated reference beams, originating from 600 of the plurality of co-locationally multiplexed holograms that comprised content related to the Search content of the content addressable search pattern input to the object beam, were also achieved using a combination of (i) increments of 0.04° for the planar-angle multiplexing, (ii) four out-of-plane tilt angles as per FIG. 18(d), and (iii) a sub Nyquist aperture corresponding to 1/10^{th} of the total Nyquist aperture area comprising ⅕ of the vertical dimension centered about the x-axis across and ½ of the horizontal dimension located on the left side of the y-axis where the y-axis is the vertical axis through the center of the horizontal intensity distribution of the Fourier transform at the recording plane.

The achieved area density result exceeded 1E3 bits/μm² by use of the above combination of dual multiplexing, sub Bragg increments for multiplexing, and sub Nyquist aperture for the area of the storage location for the multiplexed holograms. Consequently, the content addressing search rate for a holographic data storage system operable in Address Retrieval mode, that generates Address information from stored holograms so as to locate, access and retrieve related Content information separately stored in other data storage systems, can be substantially greater than from holographic storage systems which store holograms to reconstruct the content information from the holograms. For example, greater than six hundred 1 Mbit data pages per storage location can be stored in relatively thin recording material using dual multiplexing methods at sub Bragg angle increments. Consequently, on a disk media at an average track radius at 40 mm (track length of 251 mm), with use of a relatively low numerical aperture lens (i.e. NA ˜0.3) and sub Nyquist aperture conditions, there can be at least 400 storage locations along a track equating to ˜2.5E11 bits/track. At disk rotation speed of 1000 rpm (16.5 rps) or 60 msec/rotation, the detection speed per storage location is ˜0.14 msecs/location which corresponds to a compelling data rate for content addressable search rate at the mid radius track position of ˜520 GBytes/sec. By way of example, photodiode detectors have satisfactory signal to noise and sensitivity to detect such optical correlation signals at the said detection rates. Data rates for content addressable search can increase still further by factors of 3 or more with reasonable increases in numerical aperture, shorter wavelengths for recording (i.e. 407 nm), increased page size and increased rotation speed of the media.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus for information retrieval, comprising:
a first holographic drive, configured to content-search holographic recording media (HRM), and to generate an address; and
at least one data storage system, configured to receive the generated address, and operable to retrieve information from said data storage system located at the generated address.

2. The apparatus of claim 1, further including a first holographic recording media (HRM) in the first holographic drive, wherein said first HRM is content-searchable and non-retrievable.

3. The apparatus of claim 2, wherein the first HRM includes holographically stored information recorded thereon as multiplexed volume holograms.

4. The apparatus of claim 3, wherein the holographically stored information is phase-encoded.

5. The apparatus of claim 3, wherein the multiplexed holograms are recorded on the first HRM using two or more multiplexing methods.

6. The apparatus of claim 5, wherein the multiplexed holograms are recorded using two or more multiplexing methods in at least one storage location on the HRM.

7. The apparatus of claim 5, wherein the multiplexed holograms are recorded using two or more multiplexing methods in at least one storage location on the HRM, and wherein at least one multiplexing method is selected from shift-multiplexing, phase-multiplexing, out-of-plane tilt-multiplexing, phase-encoded multiplexing, and azimuthal multiplexing.

8. The apparatus of claim 3, wherein the holographically stored information recorded on the first HRM is recorded at areal density of 100 bits/μm² or more.

9. The apparatus of claim 3, wherein the multiplexed holograms recorded in at least one storage location on the first HRM are recorded at sub-Bragg angular separation or sub-Bragg wavelength separation.

10. The apparatus of claim 3, wherein the multiplexed holograms recorded in at least one storage location on the first HRM are recorded using sub-Nyquist aperture, wherein the minimum cross-sectional area of the at least one storage location is less than the Nyquist aperture of at least one object beam used to record the multiplexed holograms.

11. The apparatus of claim 10, wherein the multiplexed holograms recorded in the at least one storage location on the first HRM using sub-Nyquist aperture are recorded at sub-Bragg angular separation or sub-Bragg wavelength separation.

12. The apparatus of claim 3, wherein the multiplexed holograms, recorded in at least one storage location on the first HRM, have raw bit-error-rate (BER) of 0.01 or greater.

13. The apparatus of claim 3, wherein the multiplexed holograms, recorded in at least one storage location on the first HRM, have signal-to-noise ratio (SNR) of 2 or less.

14. The apparatus of claim 1, further including a controller for communicating with the at least one data storage system.

15. The apparatus of claim 1, wherein the at least one data storage system is selected from an on-line storage, a near-on-line storage, an off-line storage, a network attached storage systems (NAS), one or more storage attached networks (SAN), an enterprise storage system or combinations thereof.

16. The apparatus of claim 1, wherein the at least one data storage system includes one or more magnetic tape drives, hard disk drives, optical tape drives, optical disk drives, magneto-optical drives, solid state drives, or flash memory units.

17. The apparatus of claim 1, further comprising an interface for communicating with a wide area network (WAN) or one or more local area networks (LAN), or one or more campus area network (CAN), the information being transmitted to or from the at least one data storage system to the WAN or one or more LANs or one or more CANs through the interface.

18. The apparatus of claim 1, wherein the at least one data storage system is a node on a wide area network (WAN) or one or more local area networks (LAN) or one or more campus area networks (CAN).

19. The apparatus of claim 14, further comprising an interface for communicating between the controller and the at least one data storage system, wherein the interface comprises a network adapter, a data storage system, a cache or combinations thereof.

20. The apparatus of claim 1, wherein the at least one data storage system is a second holographic drive configured for address-searching a holographic recording media (HRM), said second holographic drive operable to read holographically stored information recorded on an HRM.

21. The apparatus of claim 20, further including a second holographic recording media (HRM) in the second holographic drive, wherein the second holographic media is address-searchable.

22. The apparatus of claim 21, wherein at least on storage location on the second HRM includes holographically stored information recorded thereon as multiplexed volume holograms.

23. The apparatus of claim 22, wherein the multiplexed holograms are recorded on the second HRM with at least Bragg angular separation or Bragg wavelength separation.

24. The apparatus of claim 22, wherein the multiplexed holograms are recorded on the second HRM using at least Nyquist aperture, wherein the minimum cross-sectional area of the at least one storage location is equal to or greater than the Nyquist aperture of at least one object beam used to record the multiplexed holograms.

25. The apparatus of claim 22, wherein the multiplexed holograms, recorded on the second HRM, have raw bit-error-rate (BER) of 10⁻² or less.

26. The apparatus of claim 22, wherein the multiplexed holograms, recorded on the second HRM, have signal-to-noise ratio (SNR) of 2 or more.

27. A method of information retrieval, comprising
content-searching a first holographic recording media (HRM), thereby generating correlation signals;
generating an address based on the correlation signals; and
retrieving information from at least one data storage system, said information located at the generated address.

28. The method of claim 27, wherein the first HRM is content-searchable and non-retrievable.

29. The method of claim 27, wherein the first HRM includes holographically stored information recorded thereon as multiplexed volume holograms.

30. The method of claim 29, wherein the holographically stored information is phase-encoded.

31. The method of claim 29, wherein the multiplexed holograms are recorded on the first HRM using two or more multiplexing methods.

32. The method of claim 31, wherein the multiplexed holograms are recorded using two or more multiplexing methods in at least one storage location on the first HRM.

33. The method of claim 31, wherein the multiplexed holograms are recorded using two or more multiplexing methods in at least one storage location on the first HRM, and wherein at least one multiplexing method is selected from shift-multiplexing, phase-multiplexing, out-of-plane tilt-multiplexing, phase-encoded multiplexing, and azimuthal multiplexing.

34. The method of claim 29, wherein the holographically stored information is recorded on the first HRM at areal density of 100 bits/μm² or more.

35. The method of claim 29, wherein the multiplexed holograms are recorded in at least one storage location on the first HRM at sub-Bragg angular separation or sub-Bragg wavelength separation.

36. The method of claim 29, wherein the multiplexed holograms are recorded in at least one storage location on the first HRM using sub-Nyquist aperture, wherein the minimum cross-sectional area of the at least one storage location is less than the Nyquist aperture of at least one object beam used to record the multiplexed holograms.

37. The method of claim 31, wherein the multiplexed holograms recorded in the at least one storage location on the first HRM using sub-Nyquist aperture are recorded at sub-Bragg angular separation or sub-Bragg wavelength separation.

38. The method of claim 29, wherein the multiplexed holograms recorded in at least one storage location on the first HRM have raw bit-error-rate (BER) of 0.01 or greater.

39. The method of claim 29, wherein the multiplexed holograms, recorded in at least one storage location on the first HRM have signal-to-noise ratio (SNR) of 2 or less.

40. The method of claim 27, wherein the at least one data storage system is selected from an on-line storage, a near-on-line storage, an off-line storage, a network attached storage systems (NAS), one or more storage attached networks (SAN), an enterprise storage system or combinations thereof.

41. The method of claim 27, wherein the at least one data storage system is selected from one or more magnetic tape drives, hard disk drives, optical tape drives, optical disk drives, magneto-optical drives, solid state drives, or flash memory units.

42. The method of claim 38, further including communicating with a wide area network (WAN) or one or more local area networks (LAN) or one or more campus area networks (CAN), the information being transmitted to or from the system to the WAN or one or more LANs or one or more CANs through an interface.

43. The method of claim 27, wherein the at least one data storage system is a second holographic drive configured for address-searching a holographic recording media (HRM), said second holographic drive operable to read holographically stored information recorded on an HRM.

44. The method of claim 43, wherein the information corresponding to the address generated by content-searching the first HRM is retrieved from the second HRM disposed in the second holographic drive.

45. The method of claim 44, wherein the second HRM is address-searchable.

46. The method of claim 44, wherein at least one storage location on the second HRM includes holographically stored information recorded thereon as multiplexed volume holograms.

47. The method of claim 44, wherein the multiplexed holograms are recorded on the second HRM with at least Bragg angular separation or Bragg wavelength separation.

48. The method of claim 42, wherein the multiplexed holograms are recorded on the second HRM using at least Nyquist aperture, wherein the minimum cross-sectional area of the at least one storage location is equal to or greater than the Nyquist aperture of at least one object beam used to record the multiplexed holograms.

49. The method of claim 44, wherein the multiplexed holograms recorded on the second HRM, have raw bit-error-rate (BER) of 10⁻² or less.

50. The method of claim 44, wherein the multiplexed holograms recorded on the second HRM, have signal-to-noise ratio (SNR) of 2 or more.

51. An apparatus for information retrieval, comprising:
a first holographic drive, configured to content-search holographic recording media (HRM), and to generate an address; and
a first holographic recording media (HRM) in the first holographic drive, wherein said first HRM is content-searchable and non-retrievable.

52. The apparatus of claim 51, wherein the HRM includes information holographically stored as reflection holograms.

53. The apparatus of claim 52, wherein the holographically stored information is recorded using at least two multiplexing methods.

54. An apparatus for content searching, comprising
a spatial light modulator (SLM) configured to generate a search argument beam;
a first lens element, disposed in the optical path of the search argument beam, configured to direct the search argument beam at a selected storage location in a holographic recording media (HRM) and to generate a correlation signal beam in the event of a non-zero correlation;
an elliposoidal reflector disposed in the optical path of the correlation signal beam;
a detector configured to detect the correlation signal beam,
wherein the correlation signal beam is reflected by the ellipsoidal reflector directly to the detector.

55. An apparatus for content searching, comprising
a spatial light modulator (SLM) configured to generate a search argument beam;
a first lens element, disposed in the optical path of the search argument beam, configured to direct the search argument beam at a selected storage location in a holographic recording media (HRM) and to generate a correlation signal beam in the event of a non-zero correlation by diffracting the search argument beam;
a beam dump, disposed in the optical path of the undiffracted of the search argument beam;
a second lens element, disposed in the optical path of the correlation signal beam, configured to direct the correlation signal beam to the detector;
a detector configured to detect the correlation signal beam,
wherein the correlation signal beam is diffracted from the HRM directly at the second lens element.
